(19) United States
(12) Patent Application Publication
(10) Pub. No.: US 2021/0065712 A1
(43) Pub. Date: Mar. 4, 2021

(54) AUTOMOTIVE VISUAL SPEECH RECOGNITION

(71) Applicant: SoundHound, Inc., Santa Clara, CA (US)

(72) Inventor: Steffen HOLM, San Francisco, CA (US)

(73) Assignee: SoundHound, Inc., Santa clara, CA (US)

(21) Appl. No.: 16/558,096

(22) Filed: Aug. 31, 2019

(51) Int. Cl. G10L 15/25; G10L 17/18; G06F 17/27; G06K 9/00; G10L 15/22

(52) U.S. Cl. CPC G10L 15/25; G10L 17/18; G06F 17/2705; G10L 2015/223; G10L 15/22; G06K 9/00275; G10L 2015/227; G06K 9/00281

(57) ABSTRACT

Systems and methods for processing speech are described. Certain examples use visual information to improve speech processing. This visual information may be image data obtained from within a vehicle. In examples, the image data features a person within the vehicle. Certain examples use the image data to obtain a speaker feature vector for use by an adapted speech processing module. The speech processing module may be configured to use the speaker feature vector to process audio data featuring an utterance. The audio data may be audio data derived from an audio capture device within the vehicle. Certain examples use neural network architectures to provide acoustic models to process the audio data and the speaker feature vector.

### FIELD OF THE INVENTION

The present technology is in the field of speech processing and, more specifically, related to processing speech captured from within a vehicle.

### BACKGROUND

Recent advances in computing have raised the possibility of realizing many long sought-after voice-control applications. For example, improvements in statistical models, including practical frameworks for effective neural network architectures, have greatly increased the accuracy and reliability of previous speech processing systems. This has been coupled with a rise in wide area computer networks, which offer a range of modular services that can be simply accessed using application programming interfaces. Voice is quickly becoming a viable option for providing a user interface.

While voice control devices have become popular within the home, providing speech processing within vehicles presents additional challenges. For example, vehicles often have limited processing resources for auxiliary functions (such as voice interfaces), suffer from pronounced noise (e.g., high levels of road and/or engine noise), and present constraints in terms of the internal acoustic environment of a vehicle. Any user interface is furthermore constrained by the safety implications of controlling a vehicle. These factors have made within vehicle voice control difficult to achieve in practice.

Also, despite advances in speech processing, even users of advanced computing devices often report that current systems lack human-level responsiveness and intelligence. Translating pressure fluctuations in-the-air into parsed commands is incredibly difficult. Speech processing typically involves a complex processing pipeline, where errors at any stage can derail a successful machine interpretation. Many of these challenges are not immediately apparent to human beings, who are able to process speech using cortical and sub-cortical structures without conscious thought. Engineers working in the field, however, quickly become aware of the gap between human ability and state of the art speech processing.

U.S. Pat. No. 8,442,820 B2 describes a combined lip reading and voice recognition multimodal interface system. The system can issue a navigation operation instruction only by voice and lip movements, thus allowing a driver to look ahead during a navigation operation and reducing vehicle accidents related to navigation operations during driving. The combined lip reading and voice recognition multimodal interface system described in U.S. Pat. No. 8,442,820 B2 has an audio voice input unit; a voice recognition unit; a voice recognition instruction and estimated probability output unit; a lip video image input unit; a lip reading unit; a lip reading recognition instruction output unit; and a voice recognition and lip reading recognition result combining unit that outputs the voice recognition instruction. While U.S. Pat. No. 8,442,820 B2 provides one solution for in vehicle control, the proposed system is complex and the many interoperating components present increased opportunity for error and parsing failure. Implementing practical speech processing solutions is difficult as vehicles present many challenges for system integration and connectivity. Therefore, what is needed are speech processing systems and methods that more accurately transcribe and parse human utterances. It is further desired to provide speech processing methods that may be practically implemented with real world devices, such as embedded computing systems for vehicles.

### SUMMARY OF THE INVENTION

Certain examples described herein provide methods and systems that more accurately transcribe and parse human utterances for processing speech. Certain examples use both audio data and image data to process speech. Certain examples are adapted to address challenges of processing utterances that are captured within a vehicle. Certain examples obtain a speaker feature vector based on image data that features at least a facial area of a person, e.g., a person within the vehicle. Speech processing is then performed using vision-derived information that is dependent on a speaker of an utterance to improve accuracy and robustness.

In accordance with one aspect, an apparatus for a vehicle includes an audio interface configured to receive audio data from within the vehicle, an image interface configured to receive image data from within the vehicle, and a speech processing module configured to parse an utterance of the person based on the audio data and the image data. In accordance with an embodiment of the invention, the speech processing module includes an acoustic model configured to process the audio data and predict phoneme data for use in parsing the utterance. In accordance with various aspects of the invention, the acoustic model includes a neural network architecture. The apparatus also includes a speaker preprocessing module, implemented by the processor, configured to receive the image data and obtain a speaker feature vector based on the image data, wherein the acoustic model is configured to receive the speaker feature vector and the audio data as an input and is trained to use the speaker feature vector and the audio data to predict the phoneme data.

In accordance with the various aspects of the invention, a speaker feature vector is obtained using image data that features a facial area of a talking person. This speaker feature vector is provided as an input to a neural network architecture of an acoustic model, wherein the acoustic model is configured to use this input as well as audio data featuring the utterance. In this manner, the acoustic model is provided with additional vision-derived information that the neural network architecture may use to improve the parsing of the utterance, e.g., to compensate for the detrimental acoustic and noise properties within a vehicle. For example, configuring an acoustic model based on a particular person, and/or the mouth area of that person, as determined from image data, may improve the determination of ambiguous phonemes, e.g., that without the additional information may be erroneously transcribed based on vehicle conditions.

In accordance with one embodiment, the speaker preprocessing module is configured to perform facial recognition on the image data to identify the person within the vehicle and retrieve a speaker feature vector associated with the identified person. For example, the speaker preprocessing module includes a face recognition module that is used to identify a user that is speaking within a vehicle. In cases where the speaker feature vector is determined based on audio data, the identification of the person may allow a predetermined (e.g., pre-computed) speaker feature vector to be retrieved from memory. This can improve processing latencies for constrained embedded vehicle control systems.

In accordance with one embodiment, the speaker preprocessing module includes a lip-reading module, implemented by the processor, configured to generate one or more speaker feature vectors based on lip movement within the facial area of the person. In accordance with various embodiments, the lip-reading module may be used together with, or independently of, a face recognition module. In accordance with various aspects of the invention, one or more speaker feature vectors provide a representation of a speaker's mouth or lip area used by the neural network architecture of the acoustic model to improve processing.

In accordance with various aspects, the speaker preprocessing module includes a neural network architecture, where the neural network architecture is configured to receive data derived from one or more of the audio data and the image data and predict the speaker feature vector. For example, this approach may combine vision-based neural lip-reading systems with acoustic “x-vector” systems to improve acoustic processing. In cases where one or more neural network architectures are used, these may be trained using a training set that includes image data, audio data and a ground truth set of linguistic features, such as a ground truth set of phoneme data and/or a text transcription.

In accordance with one aspect of the invention, the speaker preprocessing module is configured to compute a speaker feature vector for a predefined number of utterances and compute a static speaker feature vector based on the plurality of speaker feature vectors for the predefined number of utterances. For example, the static speaker feature vector includes an average of a set of speaker feature vectors that are linked to a particular user using the image data. The static speaker feature vector may be stored within a memory of the vehicle. This again can improve speech processing capabilities within resource-constrained vehicle computing systems.

In accordance with one embodiment, the apparatus includes memory configured to store one or more user profiles. In this case, the speaker preprocessing module is configured to perform facial recognition on the image data to identify a user profile within the memory associated with the person within the vehicle, compute a speaker feature vector for the person, store the speaker feature vector in the memory, and associate the stored speaker feature vector with the identified user profile. Facial recognition may provide a quick and convenient mechanism to retrieve useful information for acoustic processing that is dependent on a particular person (e.g., the speaker feature vector). In accordance with one aspect of the invention, the speaker preprocessing module is configured to determine whether a number of stored speaker feature vectors associated with a given user profile is greater than a predefined threshold. If this is the case, the speaker preprocessing module computes a static speaker feature vector based on the number of stored speaker feature vectors, stores the static speaker feature vector in the memory, associates the stored static speaker feature vector with the given user profile, and signal that the static speaker feature vector is to be used for future utterance passing in place of computation of the speaker feature vector for the person.

In accordance with one embodiment, the apparatus includes an image capture device configured to capture electromagnetic radiation having infra-red wavelengths, the image capture device being configured to send the image data to the image interface. This provides an illumination invariant image that improves image data processing. The speaker preprocessing module may be configured to process the image data to extract one or more portions of the image data, wherein the extracted one or more portions are used to obtain the speaker feature vector. For example, the one or more portions may relate to a facial area and/or a mouth area.

In accordance with various aspects of the invention, one or more of the audio interface, the image interface, the speech processing module and the speaker preprocessing module may be located within the vehicle, e.g., may include part of a local embedded system. The processor may be located within the vehicle. In accordance with one embodiment, the speech processing module is remote from the vehicle and the apparatus includes a transceiver to transmit data derived from the audio data and the image data to the speech processing module and to receive control data from the parsing of the utterance. Different distributed configurations are possible. For example, in accordance with some embodiments, the apparatus may be locally implemented within the vehicle and a further copy of at least one component of the apparatus may be implemented on a remote server device, such that certain functions are performed remotely, e.g., as well as or instead of local processing. Remote server devices may have enhanced processing resources that improve accuracy.

In accordance with some aspects of the invention, the acoustic model includes a hybrid acoustic model includes the neural network architecture and a Gaussian mixture model, wherein the Gaussian mixture model is configured to receive a vector of class probabilities output by the neural network architecture and to output phoneme data for parsing the utterance. The acoustic model may additionally, or alternatively, include a Hidden Markov Model (HMM), e.g., as well as the neural network architecture. In accordance with one aspect of the invention, the acoustic model includes a connectionist temporal classification (CTC) model, or another form of neural network model with recurrent neural network architectures.

In accordance with one aspect of the invention, the speech processing module includes a language model communicatively coupled to the acoustic model to receive the phoneme data and to generate a transcription representing the utterance. In this variation, the language model is configured to use the speaker feature vector to generate the transcription representing the utterance, e.g., in addition to the acoustic model. This is used to improve language model accuracy where the language model includes a neural network architecture, such as a recurrent neural network or transformer architecture.

In accordance with one aspect of the invention, the acoustic model includes a database of acoustic model configurations, an acoustic model selector to select an acoustic model configuration from the database based on the speaker feature vector, and an acoustic model instance to process the audio data. The acoustic model instance being instantiated based on the acoustic model configuration selected by the acoustic model selector. The acoustic model instance being configured to generate the phoneme data for use in parsing the utterance.

In accordance with various aspects of the invention, the speaker feature vector is one or more of an i-vector and an x-vector. The speaker feature vector includes a composite vector, e.g., that includes two or more of a first portion that is dependent on the speaker that is generated based on the audio data, a second portion that is dependent on lip movement of the speaker and generated based on the image data, and a third portion that is dependent on the speaker's face that is generated based on the image data.

According to another aspect there is a method of processing an utterance that includes receiving audio data from an audio capture device located within a vehicle, the audio data featuring an utterance of a person within the vehicle, receiving image data from an image capture device located within the vehicle, the image data featuring a facial area of the person, obtaining a speaker feature vector based on the image data, and parsing the utterance using a speech processing module implemented by a processor. Parsing the utterance includes providing the speaker feature vector and the audio data as an input to an acoustic model of the speech processing module. The acoustic model includes a neural network architecture. Parsing the utterance includes predicting, using at least the neural network architecture, phoneme data based on the speaker feature vector and the audio data.

The method may provide similar improvements to speech processing within a vehicle. In accordance with various aspects of the invention, obtaining a speaker feature vector includes performing facial recognition on the image data to identify the person within the vehicle, obtaining user profile data for the person based on the facial recognition, and obtaining the speaker feature vector in accordance with the user profile data. The method further includes comparing a number of stored speaker feature vectors associated with the user profile data with a predefined threshold. Responsive to the number of stored speaker feature vectors being below the predefined threshold, the method includes computing the speaker feature vector using one or more of the audio data and the image data. Responsive to the number of stored speaker feature vectors being greater than the predefined threshold, the method includes obtaining a static speaker feature vector associated with the user profile data, the static speaker feature vector being generated using the number of stored speaker feature vectors. In accordance with some aspects of the invention, a speaker feature vector includes processing the image data to generate one or more speaker feature vectors based on lip movement within the facial area of the person. Parsing the utterance includes providing the phoneme data to a language model of the speech processing module, predicting a transcript of the utterance using the language model, and determining a control command for the vehicle using the transcript.

According to other aspects of the invention, a non-transitory computer-readable storage medium storing instructions that, when executed by at least one processor, cause the at least one processor to receive audio data from an audio capture device, receive a speaker feature vector, the speaker feature vector being obtained based on image data from an image capture device, the image data featuring a facial area of a user, and parse the utterance using a speech processing module, including to: provide the speaker feature vector and the audio data as an input to an acoustic model of the speech processing module, the acoustic model comprising a neural network architecture, predict, using at least the neural network architecture, phoneme data based on the speaker feature vector and the audio data, provide the phoneme data to a language model of the speech processing module, and generate a transcript of the utterance using the language model.

The at least one processor includes a computing device, e.g., a computing device that is remote from a motor vehicle where the audio data and the speaker image vector are received from a motor vehicle. The instructions may enable the processor to perform automatic speech recognition with lower error rates. In accordance with some embodiments, the speaker feature vector includes vector elements that are dependent on the speaker, which are generated based on the audio data, vector elements that are dependent on lip movement of the speaker, which is generated based on the image data, and vector elements that are dependent on a face of the speaker, which is generated based on the image data.

### BRIEF DESCRIPTION OF THE DRAWINGS

FIG. 1A is a schematic illustration showing an interior of a vehicle according to an embodiment of the invention.

FIG. 1B is a schematic illustration showing an apparatus for a vehicle according to an embodiment of the invention.

FIG. 2 is a schematic illustration showing an apparatus for a vehicle with a speaker preprocessing module according to an embodiment of the invention.

FIG. 3 is a schematic illustration showing components of a speaker preprocessing module according to an embodiment of the invention.

FIG. 4 is a schematic illustration showing components of a speech processing module according to an embodiment of the invention.

FIG. 5 is a schematic illustration showing a neural speaker preprocessing module and a neural speech processing module according to an embodiment of the invention.

FIG. 6 is a schematic illustration showing components to configure an acoustic model of a speech processing module according to an embodiment of the invention.

FIG. 7 is a schematic illustration showing an image preprocessor according to an embodiment of the invention.

FIG. 8 is a schematic illustration showing image data from different image capture devices according to an embodiment of the invention.

FIG. 9 is a schematic illustration showing components of a speaker preprocessing module configured to extract lip features according to an embodiment of the invention.

FIGS. 10A and 10B are schematic illustrations showing a motor vehicle with an apparatus for speech processing according to an embodiment of the invention.

FIG. 11 is a schematic illustration showing components of a user interface for a motor vehicle according to an embodiment of the invention.

FIG. 12 is a schematic illustration showing a computing device for a vehicle according to an embodiment of the invention.

FIG. 13 is a flow diagram showing a method of processing an utterance according to an aspect of the invention.

FIG. 14 is a schematic illustration showing a non-transitory computer-readable storage medium according to an embodiment of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention. Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

Certain examples described herein use visual information to improve speech processing. This visual information may be obtained from within a vehicle. In examples, the visual information features a person within the vehicle, e.g., a driver or a passenger. Certain examples use the visual information to generate a speaker feature vector for use by an adapted speech processing module. The speech processing module may be configured to use the speaker feature vector to improve the processing of associated audio data, e.g., audio data derived from an audio capture device within the vehicle. The examples may improve the responsiveness and accuracy of in-vehicle speech interfaces. Certain examples may be used by computing devices to improve speech transcription. As such, described examples may be seen to extend speech processing systems with multi-modal capabilities that improve the accuracy and reliability of audio processing.

Certain examples described herein provide different approaches to generate a speaker feature vector. Certain approaches are complementary and may be used together to synergistically improve speech processing. In one example, image data obtained from within a vehicle, such as from a driver and/or passenger camera, is processed to identify a person and to determine a feature vector that numerically represents certain characteristics of the person. These characteristics include audio characteristics, e.g., a numerical representation of expected variance within audio data for an acoustic model. In another example, image data obtained from within a vehicle, such as from a driver and/or passenger camera, is processed to determine a feature vector that numerically represents certain visual characteristics of the person, e.g., characteristics associated with an utterance by the person. In one case, the visual characteristics may be associated with a mouth area of the person, e.g., represent lip position and/or movement. In both examples, a speaker feature vector may have a similar format, and so be easily integrated into an input pipeline of an acoustic model that is used to generate phoneme data. Certain examples may provide improvements that overcome certain challenges of in-vehicle automatic speech recognition, such as a confined interior of a vehicle, a likelihood that multiple people may be speaking within this confined interior and high levels of engine and environmental noise.

### Example Vehicle Context

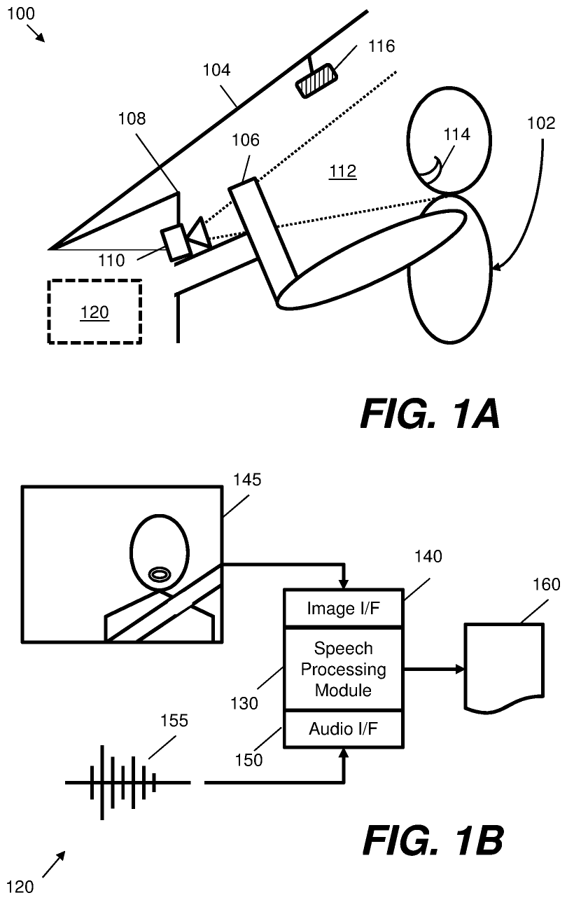

FIG. 1A shows an example context for an apparatus that performs speech processing. In FIG. 1A, the context is a motor vehicle. FIG. 1A is a schematic illustration of an interior 100 of the motor vehicle. The interior 100 is shown for a front driver side of the motor vehicle. A person 102 is shown within the interior 100. In FIG. 1A, the person is a driver of the motor vehicle. The person 102 faces forward in the vehicle and observes a road through windshield 104. The person 102 controls the vehicle using a steering wheel 106 and observes vehicle status indications via a dashboard or instrument panel 108. In FIG. 1A, an image capture device 110 is located within the interior 100 of the motor vehicle near the bottom of a dashboard 108. The image capture device 110 has a field of view 112 that captures a facial area 114 of the person 102. In this example, the image capture device 110 is positioned to capture an image through an aperture of or an opening in the steering wheel 106. FIG. 1A also shows an audio capture device 116 that is located within the interior 100 of the motor vehicle. The audio capture device 116 is arranged to capture sounds that are made by the person 102. For example, the audio capture device 116 may be arranged to capture speech from the person 102, i.e. sounds that are emitted from the facial area 114 of the person 102. In accordance with one embodiment, the audio capture device 116 is shown mounted to the windshield 104. In accordance with other embodiments, the audio capture device 116 may be mounted near to or on a rear-view mirror, or be mounted on a door frame to one side of the person 102. FIG. 1A also shows a speech processing apparatus 120. In accordance with one embodiment, the speech processing apparatus 120 is part of a control system of the motor vehicle. In accordance with one embodiment, the speech processing apparatus 120 is remotely located and in communication with the control system of the motor vehicle. In the example of FIG. 1A, the image capture device 110 and the audio capture device 116 are in communication with the speech processing apparatus 120, e.g., via one or more wired and/or wireless interfaces. The image capture device 110 can be located outside the motor vehicle to capture an image within the motor vehicle through window glasses of the motor vehicle.

The context and configuration of FIG. 1A is provided as an example to aid understanding of the following description. It should be noted that the examples need not be limited to a motor vehicle and may be similarly implemented in other forms of vehicles including, but not limited to: nautical vehicles such as boats and ships; aerial vehicles such as helicopters, planes and gliders; railed vehicles such as trains and trams; spacecraft, construction vehicles and heavy equipment. Motor vehicles may include cars, trucks, sports utility vehicles, motorbikes, buses, and motorized carts, amongst others. Use of the term “vehicle” herein also includes certain heavy equipment that may be motorized while remaining static, such as cranes, lifting devices and boring devices. Vehicles may be manually controlled and/or have autonomous functions. Vehicles, as used herein, may be motorized or man-powered, such as a bicycle. Although the example of FIG. 1A features a steering wheel 106 and dashboard 108, other control arrangements may be provided (e.g., an autonomous vehicle may not have a steering wheel 106 as depicted). Although a driver seat context is shown in FIG. 1A, a similar configuration may be provided for one or more passenger seats (e.g. both front and rear). FIG. 1A is provided for illustration only and omits certain features, which may also be found within a vehicle, for clarity. In certain cases, the approaches described herein may be used outside of a vehicle context, e.g., may be implemented by a computing device such as a desktop or laptop computer, a smartphone, or an embedded device.

FIG. 1B is a schematic illustration of the speech processing apparatus 120 shown in FIG. 1A. In FIG. 1B, the speech processing apparatus 120 includes a speech processing module 130, an image interface 140 and an audio interface 150. The image interface 140 is configured to receive image data 145. The image data 145 includes image data captured by the image capture device 110 in FIG. 1A. The audio interface 150 is configured to receive audio data 155. The audio data 155 includes audio data captured by the audio capture device 116 in FIG. 1A. The speech processing module 130 is in communication with both the image interface 140 and the audio interface 150. The speech processing module 130 is configured to process the image data 145 and the audio data 155 to generate a set of linguistic features 160 that are useable to parse an utterance of the person 102. The linguistic features 160 includes phonemes, word portions (e.g., stems or proto-words), and words (including text features such as pauses that are mapped to punctuation), as well as probabilities and other values that relate to these linguistic units. In one case, the linguistic features 160 may be used to generate a text output that represents the utterance. In accordance with various aspects of the invention, the text output may be used as-is or may be mapped to a predefined set of commands and/or command data. In accordance with other aspects of the invention, the linguistic features 160 may be directly mapped to the predefined set of commands and/or command data (e.g. without an explicit text output).

A person (such as person 102) may use the configuration of FIGS. 1A and 1B to issue voice commands while operating the motor vehicle. For example, the person 102 may speak within the interior, e.g., generate an utterance, in order to control the motor vehicle or obtain information. An utterance in this context is associated with a vocal sound produced by the person and the utterance represents linguistic information such as speech. For example and in accordance with one aspect of the invention, an utterance includes speech that emanates from a larynx of the person 102. The utterance includes a voice command, e.g., a spoken request from a user. The voice command includes, for example, any one or any combination of: a request to perform an action (e.g., “Play music”, “Turn on air conditioning”, “Activate cruise control”); a request for further information relating to a request (e.g., “Album XY”, “68 degrees Fahrenheit”, “60 mph for 30 minutes”); speech to be transcribed (e.g., “Add to my to-do list . . . ” or “Send the following message to user A . . . ”); and/or a request for information (e.g., “What is the traffic like on C?”, “What is the weather like today?”, or “Where is the nearest gas station?”).

The audio data 155 may take a variety of forms depending on the implementation. In general, the audio data 155 may be derived from time series measurements from one or more audio capture devices (e.g., one or more microphones), such as audio capture device 116 in FIG. 1A. In accordance with some embodiments, the audio data 155 is captured from one audio capture device; in accordance with other embodiments, the audio data 155 is captured from multiple audio capture devices, e.g., there may be multiple microphones at different positions within the interior 100. In the latter case, the audio data 155 includes one or more channels of temporally correlated audio data from each audio capture device. Audio data 155 at the point of capture includes, for example, one or more channels of Pulse Code Modulation (PCM) data at a predefined sampling rate (e.g., 16 kHz), where each sample is represented by a predefined number of bits (e.g., 8, 16 or 24 bits per sample—where each sample includes an integer or float value).

In accordance with one aspect of the invention, the audio data 155 is processed after capture and before receipt at the audio interface 150 (e.g., preprocessed with respect to speech processing). Processing includes one or more of filtering in one or more of the time and frequency domains, applying noise reduction, and/or normalization. In one case, audio data may be converted into measurements over time in the frequency domain, e.g., by performing the Fast Fourier Transform to create one or more frames of spectrogram data. In certain cases, filter banks may be applied to determine values for one or more frequency domain features, such as Mel filter banks or Mel-Frequency Cepstral Coefficients. In these cases, the audio data 155 includes an output of one or more filter banks. In other cases, audio data 155 includes time domain samples and preprocessing is performed within the speech processing module 130. Different combinations of approach are possible. In accordance with the aspects and embodiments of the invention, the audio data 155, as received at the audio interface 150, includes any measurement made along an audio processing pipeline.

In a similar manner to the audio data 155, the image data 145 described herein takes a variety of forms depending on the implementation. In accordance with one embodiment, the image capture device 110 includes a video capture device, wherein the image data 145 includes one or more frames of video data. In accordance with one embodiment, the image capture device 110 includes a static image capture device, wherein the image data 145 includes one or more frames of static images. Hence, the image data 145 is derived from both video and static sources. Reference to image data herein may relate to image data derived, for example, from a two-dimensional array having a height and a width (e.g., equivalent to rows and columns of the array). In accordance with one embodiment, the image data includes multiple color channels, e.g., three color channels for each of the colors Red Green Blue (RGB), where each color channel has an associated two-dimensional array of color values (e.g., at 8, 16 or 24 bits per array element). Color channels may also be referred to as different image “planes”. In certain cases, only a single channel may be used, e.g., representing a “gray” or lightness channel. Different color spaces may be used depending on the application, e.g., an image capture device may natively generate frames of YUV image data featuring a lightness channel Y (e.g., luminance) and two opponent color channels U and V (e.g., two chrominance components roughly aligned blue-green and red-green). As with the audio data 155, the image data 145 may be processed following capture, e.g., one or more image filtering operations may be applied and/or the image data 145 may be resized and/or cropped.

With reference to the example of FIGS. 1A and 1B and in accordance with various embodiments, one or more of the image interface 140 and the audio interface 150 may be local to hardware within the motor vehicle. For example, each of the image interface 140 and the audio interface 150 include a wired coupling of respective image capture devices and audio capture devices to at least one processor configured to implement the speech processing module 130. In accordance with one embodiment, the image interface 140 and the audio interface 140 include a serial interface, over which image data 145 and audio data 155 are received. In accordance with one embodiment that includes a distributed vehicle control system, the image interface 140 and the audio interface 150 are communicatively coupled to a central systems bus and the image data 145 and the audio data 155 are stored in one or more storage devices (e.g., Random Access Memory or solid-state storage). Accordingly, the image interface 140 and the audio interface 150 include a communicative coupling to the at least one processor configured to implement the speech processing module 130 and to the one or more storage devices. Thus, in accordance with the various embodiments, the at least one processor is configured to read data from a given memory location to access each of the image data 145 and the audio data 155. In accordance with some embodiments, the image interface 140 and the audio interface 150 include wireless interfaces, wherein the speech processing module 130 is remote from the motor vehicle. Different approaches and combinations are possible.

Although FIG. 1A shows an example where the person 102 is a driver of a motor vehicle, in other applications, one or more image capture devices and audio capture devices may be arranged to capture image data featuring a person that is not controlling the motor vehicle, such as a passenger. For example, a motor vehicle may have a plurality of image capture devices arranged to capture image data relating to people present in one or more passenger seats of the vehicle (e.g., at different locations within the vehicle such as front and back). Audio capture devices may also be arranged to capture utterances from different people, e.g., a microphone may be located in each door or door frame of the vehicle. In accordance with one embodiment, a plurality of audio capture devices are provided within the vehicle and audio data is captured from one or more of these for the supply of audio data to the audio interface 150. In accordance with one aspect, preprocessing of audio data includes selecting audio data from a channel that is deemed to be closest to a person making an utterance. In accordance with one aspect, audio data from multiple channels within the motor vehicle are combined. As described later, certain examples described herein facilitate speech processing in a vehicle with multiple passengers.

### Example Speaker Preprocessing Module

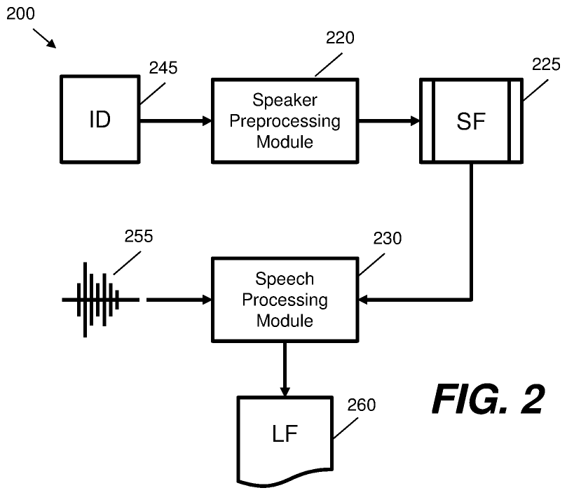

FIG. 2 shows a block diagram of a speech processing apparatus 200. The speech processing apparatus 200 is used to implement the speech processing apparatus 120 shown in FIGS. 1A and 1B. In accordance with one embodiment, the speech processing apparatus 200 forms part of an in-vehicle automatic speech recognition system. In accordance with one embodiment, the speech processing apparatus 200 is used outside of a vehicle, such as in the home or in an office. In accordance with one embodiment, the speech processing apparatus 200 includes the ability to communicate with any vehicles control system or any home or office control system.

The speech processing apparatus 200 includes a speaker preprocessing module 220 and a speech processing module 230. The speech processing module 230 may be similar to the speech processing module 130 of FIG. 1B. In this example, the image interface 140 and the audio interface 150, both of which are shown in FIG. 1B, have been omitted for clarity; the image interface 140 and the audio interface 150, respectively, form part of the image input of the speaker preprocessing module 220 and the audio input for the speech processing module 230. The speaker preprocessing module 220 is configured to receive image data 245 and to output a speaker feature vector 225. The speech processing module 230 is configured to receive audio data 255 and the speaker feature vector 225 and to use these to generate linguistic features 260.

In accordance with one embodiment, the speech processing module 230 is implemented by a processor. The processor may be a processor of a local embedded computing system within a vehicle and/or a processor of a remote server computing device (a so-called “cloud” processing device). In accordance with one embodiment, the processor includes part of a dedicated speech processing hardware, e.g., one or more Application Specific Integrated Circuits (ASICs), Field Programmable Gate Arrays (FPGAs) and so-called “system on chip” (SoC) components. In accordance with another embodiment, the processor is configured to process computer program code, e.g., firmware or the like, stored within an accessible storage device and loaded into memory for execution by the processor. The speech processing module 230 is configured to parse an utterance of a person, e.g., person 102, based on the audio data 255 and the image data 245. In accordance with one embodiment, the image data 245 is preprocessed by the speaker preprocessing module 220 to generate the speaker feature vector 225. Similar to the speech processing module 230, the speaker preprocessing module 220 may be any combination of hardware and software. In accordance with one embodiment, the speaker preprocessing module 220 and the speech processing module 230 may be implemented on a common embedded circuit board for a vehicle.

In accordance with one embodiment, the speech processing module 230 includes an acoustic model configured to process the audio data 255 and to predict phoneme data for use in parsing the utterance. In this case, the linguistic features 260 includes phoneme data. The phoneme data may relate to one or more phoneme symbols, e.g., from a predefined alphabet or dictionary. In accordance with one aspect, the phoneme data includes a predicted sequence of phonemes. In accordance with another embodiment, the phoneme data includes probabilities for one or more of a set of phoneme components, e.g., phoneme symbols and/or sub-symbols from the predefined alphabet or dictionary, and a set of state transitions (e.g., for a Hidden Markov Model). In accordance with some aspects, the acoustic model is configured to receive audio data in the form of an audio feature vector. The audio feature vector includes numeric values representing one or more of Mel Frequency Cepstral Coefficients (MFCCs) and Filter Bank outputs. In accordance with one aspect, the audio feature vector is relate to a current window within time (often referred to as a “frame”) and includes differences relating to changes in features between the current window and one or more other windows in time (e.g., previous windows). The current window may have a width within a w millisecond range, e.g. in one case w may be around 25 milliseconds. Other features include signal energy metrics and an output of logarithmic scaling, amongst others. The audio data 255, following preprocessing, includes a frame (e.g. a vector) of a plurality of elements (e.g. from 10 to over 1000 elements), each element including a numeric representation associated with a particular audio feature. In certain examples, there may be around 25-50 Mel filter bank features, a similar sized set of intra features, a similar sized set of delta features (e.g., representing a first-order derivative), and a similar sized set of double delta features (e.g., representing a second-order derivative).

In accordance with various aspects of the invention, the speaker preprocessing module 220 is configured to obtain the speaker feature vector 225 in a number of different ways. In accordance with one embodiment, the speaker preprocessing module 220 obtains at least a portion of the speaker feature vector 225 from memory, e.g., via a look-up operation. In accordance with one embodiment, a portion of the speaker feature vector 225 includes an i and/or x vector, as set out below, that is retrieved from memory. Accordingly, the image data 245 is used to determine a particular speaker feature vector 225 to retrieve from memory. For example, the image data 245 may be classified by the speaker preprocessing module 220 to select one particular user from a set of registered users. The speaker feature vector 225 in this case includes a numeric representation of features that are correlated with the selected particular user. In accordance with one aspect, the speaker preprocessing module 220 computes the speaker feature vector 225. For example, the speaker preprocessing module 220 may compute a compressed or dense numeric representation of salient information within the image data 245. This includes a vector having a number of elements that is smaller in size than the image data 245. The speaker preprocessing module 220 in this case may implement an information bottleneck to compute the speaker feature vector 225. In accordance with one aspect, the computation is determined based on a set of parameters, such as a set of weights, biases and/or probability coefficients. Values for these parameters may be determined via a training phase that uses a set of training data. In accordance with one embodiment, the speaker feature vector 225 may be buffered or stored as a static value following a set of computations. Accordingly, the speaker feature vector 225 is retrieved from a memory on a subsequent utterance based on the image data 245. Further examples explaining how a speaker feature vector is computed are set out below. In accordance with one aspect and embodiment, the speaker feature vector 225 includes a component that relates to lip movement. This component may be provided on a real-time or near real-time basis and may not be retrieved from data storage.

In accordance with one embodiment, a speaker feature vector 225 includes a fixed length one-dimensional array (e.g., a vector) of numeric values, e.g., one value for each element of the array. In accordance with other embodiments, the speaker feature vector 225 includes a multi-dimensional array, e.g. with two or more dimensions representing multiple one-dimensional arrays. The numeric values include integer values (e.g., within a range set by a particular bit length—8 bits giving a range of 0 to 255) or floating-point values (e.g., defined as 32-bit or 64-bit floating point values). Floating-point values may be used if normalization is applied to the visual feature tensor, e.g., if values are mapped to a range of 0 to 1 or −1 to 1. The speaker feature vector 225, as an example, includes a 256-element array, where each element is an 8 or 16-bit value, although the form may vary based on the implementation. In general, the speaker feature vector 225 has an information content that is less than a corresponding frame of image data, e.g., using the aforementioned example, a speaker feature vector 225 of length 256 with 8-bit values is smaller than a 640 by 480 video frame having 3 channels of 8-bit values—2048 bits vs 7372800 bits. Information content may be measured in bits or in the form of an entropy measurement.

In accordance with one embodiment, the speech processing module 230 includes an acoustic model and the acoustic model includes a neural network architecture. For example, the acoustic model includes one or more of: a Deep Neural Network (DNN) architecture with a plurality of hidden layers; a hybrid model comprising a neural network architecture and one or more of a Gaussian Mixture Model (GMM) and a Hidden Markov Model (HMM); and a Connectionist Temporal Classification (CTC) model, e.g., comprising one or more recurrent neural networks that operates over sequences of inputs and generates sequences of linguistic features as an output. The acoustic model outputs predictions at a frame level (e.g., for a phoneme symbol or sub-symbol) and use previous (and in certain cases future) predictions to determine a possible or most likely sequence of phoneme data for the utterance. Approaches, such as beam search and the Viterbi algorithm, are used on an output end of the acoustic model to further determine the sequence of phoneme data that is output from the acoustic model. Training of the acoustic model may be performed time step by time step.

In accordance with one embodiment, where the speech processing module 230 includes an acoustic model and the acoustic model includes a neural network architecture (e.g., is a “neural” acoustic model), the speaker feature vector 225 is provided as an input to the neural network architecture together with the audio data 255. The speaker feature vector 225 and the audio data 255 may be combined in a number of ways. In a simple case, the speaker feature vector 225 and the audio data 255 are concatenated into a longer combined vector. In accordance with other aspects and embodiments, different input preprocessing is performed on each of the speaker feature vector 225 and the audio data 255, e.g., one or more attention, feed-forward and/or embedding layers are applied and then the result of these layers are combined. Different sets of layers may be applied to the different inputs. In accordance with one embodiment, the speech processing module 230 includes another form of statistical model, e.g., a probabilistic acoustic model, wherein the speaker feature vector 225 includes one or more numeric parameters (e.g., probability coefficients) to configure the speech processing module 230 for a particular speaker.

The example speech processing apparatus 200 provides improvements for speech processing within a vehicle. Within a vehicle there may be high levels of ambient noise, such as road and engine noise. There may also be acoustic distortions caused by the enclosed interior space of the motor vehicle. These factors make it difficult to process audio data in comparative examples, e.g., the speech processing module 230 may fail to generate linguistic features 260 and/or generate poorly matching sequences of linguistic features 260. The arrangement of FIG. 2 allows the speech processing module 230 to be configured or adapted based on speaker features determined based on the image data 245. This provides additional information to the speech processing module 230 such that it may select linguistic features that are consistent with a particular speaker, e.g., by exploiting correlations between appearance and acoustic characteristics. These correlations may be long-term temporal correlations, such as general facial appearance, and/or short-term temporal correlations, such as particular lip and mouth positions. This leads to greater accuracy despite the challenging noise and acoustic context. This reduces utterance parsing errors, improves an end-to-end transcription path, and/or improves the audio interface for performing voice commands. In accordance with various aspects and embodiments, the system takes advantage of an existing driver-facing camera that is normally configured to monitor the driver to check for drowsiness and/or distraction. In accordance with various aspects and embodiments, the system uses a speaker dependent feature vector component, which is retrieved based on a recognized speaker, and/a speaker dependent feature vector component that includes mouth movement features. The latter component may be determined based on a function that is not configured for individual users, e.g. a common function for all users may be applied, even though the mouth movement would be associated with a speaker. In accordance with various aspects and embodiments, the extraction of mouth movement features is configured based on a particular identified user.

### Face Recognition Example

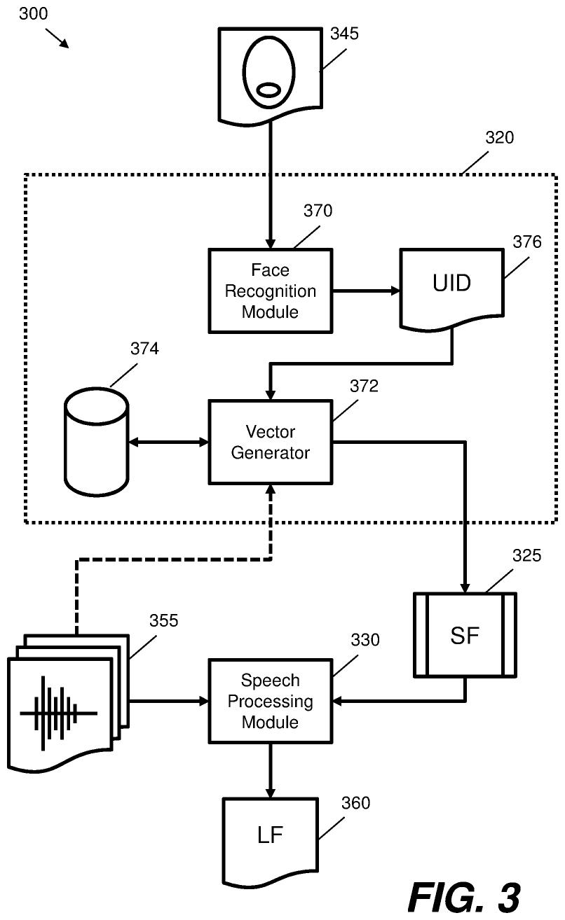

FIG. 3 shows a speech processing apparatus 300 in accordance with various aspects and embodiments of the invention. The speech processing apparatus 300 includes components that may be used to implement the speaker preprocessing module 220 in FIG. 2. Certain components shown in FIG. 3 are similar to their counterparts shown in FIG. 2 and have similar reference numerals. The features described above with reference to FIG. 2 may also apply to the example 300 of FIG. 3. Like the example speech processing apparatus 200 of FIG. 2, the example speech processing apparatus 300 of FIG. 3 includes a speaker preprocessing module 320 and a speech processing module 330. The speech processing module 330 receives audio data 355 and a speaker feature vector 325 and computes a set of linguistic features 360. The speech processing module 330 is configured in a similar manner to the examples described above with reference to FIG. 2.

In FIG. 3, a number of subcomponents of the speaker preprocessing module 320 are shown. These include a face recognition module 370, a vector generator 372 and a data store 374. Although these are shown as subcomponents of the speaker preprocessing module 320 in FIG. 3, in other embodiments they may be implemented as separate components. In the example of FIG. 3, the speaker preprocessing module 320 receives image data 345 that features a facial area of a person. The person includes a driver or passenger in a vehicle as described above. The face recognition module 370 performs facial recognition on the image data 345 to identify the person, e.g., the driver or passenger within the vehicle. The face recognition module 370 includes any combination of hardware and software to perform the facial recognition. In accordance with various one embodiment, the face recognition module 370 is implemented using an off-the-shelf hardware component such as a B5T-007001 supplied by Omron Electronics Inc. In accordance with various aspects and embodiments, the face recognition module 370 detects a user (the person) based on the image data 345 and outputs a user identifier 376. The user identifier 376 is passed to the vector generator 372. The vector generator 372 uses the user identifier 376 to obtain a speaker feature vector 325 associated with the identified person. In accordance with various aspects and embodiments, the vector generator 372 retrieves the speaker feature vector 325 from the data store 374. The speaker feature vector 325 is then passed to the speech processing module 330 for use as described with reference to FIG. 2.

In the example of FIG. 3, the vector generator 372 may obtain the speaker feature vector 325 in different ways depending on a set of operating parameters. In accordance with one embodiment, the operating parameters includes a parameter that indicates whether a particular number of speaker feature vectors 325 have been computed for a particular identified user (e.g., as identified by the user identifier 376). In accordance with various aspects and embodiments, a threshold is defined that is associated with a number of previously computed speaker feature vectors. If this threshold is 1, then the speaker feature vector 325 is computed for a first utterance and then stored in the data store 374; for subsequent utterances the speaker feature vector 325 may be retrieved from the data store 374. If the threshold is greater than 1, such as n, then n speaker feature vectors 325 are generated and then the (n+1)th speaker feature vector 325 may be obtained as a composite function of the previous n speaker feature vectors 325 as retrieved from the data store 374. The composite function includes an average or an interpolation. In accordance with various aspects and embodiments, once the (n+1)th speaker feature vector 325 is computed, it is used as a static speaker feature vector for a configurable number of future utterances.

In the example above, the use of the data store 374 to save a speaker feature vector 325 reduces run-time computational demands for an in-vehicle system. For example, the data store 374 includes a local data storage device within the vehicle and, as such, a speaker feature vector 325 is retrieved for a particular user from the data store 374 rather than being computed by the vector generator 372.

In accordance with one embodiment, at least one computation function used by the vector generator 372 involves a cloud processing resource (e.g., a remote server computing device). In this case, in situations of limited connectivity between a vehicle and a cloud processing resource, the speaker feature vector 325 is retrieved as a static vector from local storage rather than relying on any functionality that is provided by the cloud processing resource.

In accordance one embodiment, the speaker preprocessing module 320 is configured to generate a user profile for each newly recognized person within the vehicle. For example, prior to, or on detection of an utterance, e.g., as captured by an audio capture device, the face recognition module 370 attempts to match image data 345 against previously observed faces. If no match is found, then the face recognition module 370 generates (or instruct the generation of) a new user identifier 376. In accordance with various aspects and embodiments, a component of the speaker preprocessing module 320, such as the face recognition module 370 or the vector generator 372, is configured to generate a new user profile if no match is found, where the new user profile may be indexed using the new user identifier. Speaker feature vectors 325 are then associated with the new user profile. The new user profile is stored in the data store 374 ready to be retrieved when future matches are made by the face recognition module 370. As such an in-vehicle image capture device may be used for facial recognition to select a user-specific speech recognition profile. User profiles may be calibrated through an enrollment process, such as when a driver first uses the car, or may be learnt based on data collected during use.

In accordance with various aspects and embodiments, the speaker preprocessing module 320 is configured to perform a reset of data store 374. At manufacturing time, the data store 374 may be empty of user profile information. During usage, new user profiles may be created and added to the data store 374 as described above. A user may command a reset of stored user identifiers. In accordance with various aspects and embodiments, reset may be performed only during professional service, such as when an automobile is maintained at a service shop or sold through a certified dealer. In accordance with various aspects and embodiments, reset may be performed at any time through a user provided password.

In accordance with various aspects and embodiments, the vehicle includes multiple image capture devices and multiple audio capture devices. As such, the speaker preprocessing module 320 provides further functionality to determine an appropriate facial area from one or more captured images. In accordance with one embodiment, audio data from a plurality of audio capture devices may be processed to determine a closest audio capture device associated with the utterance. In this case, a closest image capture device associated with the determined closest audio capture device may be selected and image data 345 from this device (the selected closest device) may be sent to the face recognition module 370. In another case, the face recognition module 370 may be configured to receive multiple images from multiple image capture devices, where each image includes an associated flag to indicate whether it is to be used to identify a currently speaking person or user. In this manner, the speech processing apparatus 300 of FIG. 3 may be used to identify a speaker from a plurality of people within a vehicle and configure the speech processing module 330 to the specific characteristics of that speaker. This improves speech processing within a vehicle in a case where multiple people (speakers) are speaking within a constrained interior of the vehicle.

### i-vectors

In certain examples described herein, a speaker feature vector, such as speaker feature vector 225 or 325, includes data that is generated based on the audio data, e.g., audio data 255 or 355 in FIGS. 2 and 3. This is shown by the dashed line in FIG. 3. In accordance with various aspects and embodiments, at least a portion of the speaker feature vector includes a vector generated based on factor analysis. In this case, an utterance may be represented as a vector M that is a linear function of one or more factors. The factors may be combined in a linear and/or a non-linear model. One of these factors includes a speaker and session independent supervector m. This may be based on a Universal Background Model (UBM). Another one of these factors includes a speaker-dependent vector w. This latter factor may also be dependent on a channel or session or a further factor may be provided that is dependent on the channel and/or the session. In one case, the factor analysis is performed using a Gaussian Mixture Model (GMM) mixture. In a simple case, a speaker utterance may be represented by a supervector M that is determined as M=m+Tw, where Tis a matrix defining at least a speaker subspace. The speaker-dependent vector w may have a plurality of elements with floating point values. The speaker feature vector in this case may be based on the speaker-dependent vector w. One method of computing w, which is sometimes referred to as an “i-vector”, is described by Najim Dehak, Patrick Kenny, Reda Dehak, Pierre Dumouchel, and Pierre Ouellet, in their paper “Front-End Factor Analysis For Speaker Verification”, published in the IEEE Transactions On Audio, Speech And Language Processing 19, no. 4, pages 788-798, in 2010, which is incorporated herein by reference. In certain examples, at least a portion of the speaker feature vector includes at least portions of an i-vector. The i-vector may be seen to be a speaker dependent vector that is determined for an utterance from the audio data.

In the example of FIG. 3, the vector generator 372 may compute an i-vector for one or more utterances. In a case, where there are no speaker feature vectors stored within data store 374, an i-vector may be computed by the vector generator 372 based on one or more frames of audio data for an utterance 355. In this example, the vector generator 372 may repeat the per-utterance (e.g., per voice query) i-vector computation until a threshold number of computations have been performed for a particular user, e.g., as identified using the user identifier 376 determined from the face recognition module 370. In this case, after a particular user has been identified based on the image data 345, the i-vector for the user for each utterance is stored in the data store 374. The i-vector is also used to output the speaker feature vector 325. Once the threshold number of computations have been performed, e.g., 100 or so i-vectors have been computed, the vector generator 372 computes a profile for the particular user using the i-vectors that are stored in the data store 374. The profile may use the user identifier 376 as an index and includes a static (e.g., non-changing) i-vector that is computed as a composite function of the stored i-vectors. The vector generator 372 may be configured to compute the profile on receipt of a (n+1)th query or as part of a background or periodic function. In one case, a static i-vector may be computed as an average of the stored i-vectors. Once the profile is generated by the vector generator 372 and stored in the data store 374, e.g., using the user identifier to associate the profile with the particular user, then it may be retrieved from the data store 374 and used for future utterance parsing in place of computation of the i-vector for the user. This reduces the computation overhead of generating the speaker feature vector and reduce i-vector variance.

### x Vectors

In accordance with various aspects and embodiments, the speaker feature vector, such as speaker feature vector 225 or 325 may be computed using a neural network architecture. For example, the vector generator 372 of the speaker preprocessing module 320 of FIG. 3 includes a neural network architecture. In accordance this embodiment, the vector generator 372 computes at least a portion of the speaker feature vector by reducing the dimensionality of the audio data 355. For example, the vector generator 372 includes one or more Deep Neural Network layers that are configured to receive one or more frames of audio data 355 and output a fixed length vector output (e.g., one vector per language). One or more pooling, non-linear functions and softmax layers may also be provided. In accordance with various aspects and embodiments, the speaker feature vector is generated based on an x-vector as described by David Snyder, Daniel Garcia-Romero, Alan McCree, Gregory Sell, Daniel Povey, and Sanjeev Khudanpur in the paper “Spoken Language Recognition using X-vectors” published in Odyssey in 2018 (pp. 105-111), which is incorporated herein by reference.

An x-vector may be used in a similar manner to the i-vector described above, and the above approaches apply to a speaker feature vector generated using x-vectors as well as i-vectors. In accordance with various aspects and embodiments, both i-vectors and x-vectors may be determined, and the speaker feature vector includes a supervector that includes elements from both an i-vector and an x-vector. As both i-vectors and x-vectors include numeric elements, e.g., typically floating-point values and/or values normalized within a given range, that may be combined by concatenation or a weighted sum. In this case, the data store 374 includes stored values for one or more of i-vectors and x-vectors, whereby once a threshold is reached a static value is computed and stored with a particular user identifier for future retrieval. In one case, interpolation may be used to determine a speaker feature vector from one or more i-vectors and x-vectors. In one case, interpolation is performed by averaging different speaker feature vectors from the same vector source.

In the embodiments where the speech processing module includes a neural acoustic model, a fixed-length format for the speaker feature vector is defined. The neural acoustic model may then be trained using the defined speaker feature vector, e.g., as determined by the speaker preprocessing module 220 or 320 in FIGS. 2 and 3, respectively. If the speaker feature vector includes elements derived from one or more of i-vector and x-vector computations, then the neural acoustic model may “learn” to configure acoustic processing based on speaker specific information that is embodied or embedded within the speaker feature vector. This increases acoustic processing accuracy, especially within a vehicle such as a motor vehicle. In these embodiments, the image data provides a mechanism to quickly associate a particular user with computed or stored vector elements.

### Example Speech Processing Module

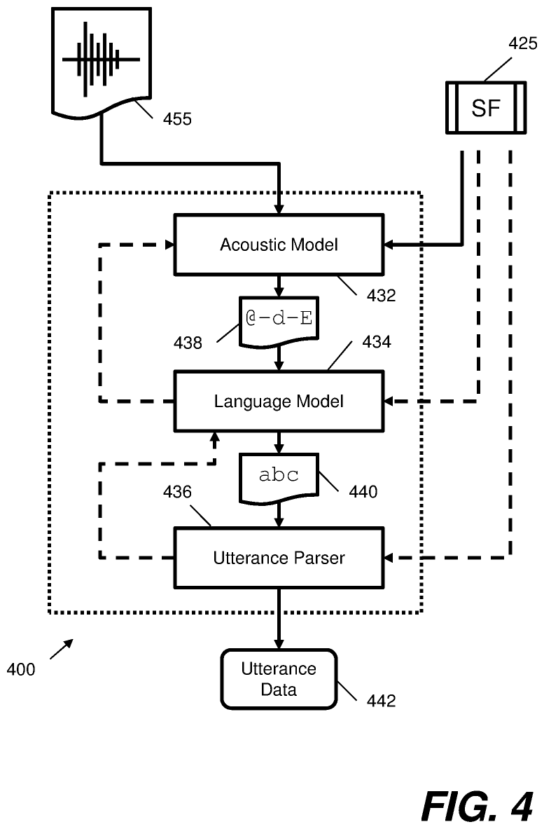

FIG. 4 shows a speech processing module 400 in accordance with various aspects and embodiments. The speech processing module 400 may be used to implement the speech processing modules 130, 230 or 330 in FIGS. 1, 2 and 3, respectively. In other examples, other speech processing module configurations may be used.

As per the previous examples, the speech processing module 400 receives audio data 455 and a speaker feature vector 425. The audio data 455 and the speaker feature vector 425 may be configured as per any of the examples described herein. In the example of FIG. 4, the speech processing module 400 includes an acoustic model 432, a language model 434 and an utterance parser 436. As described previously, the acoustic model 432 generates phoneme data 438. Phoneme data includes one or more predicted sequences of phoneme symbols or sub-symbols, or other forms of proto-language units. In certain cases, multiple predicted sequences may be generated together with probability data indicating a likelihood of particular symbols or sub-symbols at each time step.

The phoneme data 438 is communicated to the language model 434, e.g., the acoustic model 432 is in communication with the language model 434. The language model 434 is configured to receive the phoneme data 438 and generate a transcription 440. The transcription 440 includes text data, e.g., a sequence of characters, word-portions (e.g., stems, endings and the like) or words. The characters, word-portions and words may be selected from a predefined dictionary, e.g., a predefined set of possible outputs at each time step. In accordance with various aspects, the phoneme data 438 is processed before passing to the language model 434. In accordance with some aspects, the phoneme data 438 is pre-processed by the language model 434. For example, beam forming may be applied to probability distributions (e.g. for phonemes) that are output from the acoustic model 432.

The language model 434 is in communication with an utterance parser 436. The utterance parser 436 receives the transcription 440 and uses this to parse the utterance. In accordance with various aspects and embodiments, the utterance parser 436 generates utterance data 442 as a result of parsing the utterance. The utterance parser 436 is configured to determine a command, and/or command data, associated with the utterance based on the transcription 440. In accordance one aspect, the language model 434 generates multiple possible text sequences, e.g., with probability information for units within the text, and the utterance parser 436 determines a finalized text output, e.g., in the form of ASCII or Unicode character encodings, or a spoken command or command data. If the transcription 440 is determined to contain a voice command, the utterance parser 436 executes, or instructs execution of, the command according to the command data. This results in response data that is output as utterance data 442. Utterance data 442 includes a response to be relayed to the person speaking the utterance, e.g., command instructions to provide an output on the dashboard 108 and/or via an audio system of the vehicle. In certain cases, the language model 434 includes a statistical language model and the utterance parser 436 includes a separate “meta” language model configured to rescore alternate hypotheses as output by the statistical language model. This may be via an ensemble model that uses voting to determine a final output, e.g., a final transcription or command identification.

FIG. 4 shows with a solid line an example where the acoustic model 432 receives the speaker feature vector 425 and the audio data 455 as an input and uses the input to generate the phoneme data 438. For example, the acoustic model 432 includes a neural network architecture (including hybrid models with other non-neural components) and the speaker feature vector 425 and the audio data 455 may be provided as an input to the neural network architecture, wherein the phoneme data 438 is generated based on an output of the neural network architecture.

The dashed lines in FIG. 4 show additional couplings that, accordance with various aspects and embodiments, may be configured in certain implementations. In a first case, the speaker feature vector 425 is accessed by one or more of the language model 434 and the utterance parser 436. For example, if the language model 434 and the utterance parser 436 also include respective neural network architectures, these architectures may be configured to receive the speaker feature vector 425 as an additional input, e.g., in addition to the phoneme data 438 and the transcription 440 respectively. If the utterance data 442 includes a command identifier and one or more command parameters, the complete speech processing module 400 is trained in an end-end-to-end manner given a training set with ground truth outputs and training samples for the audio data 455 and the speaker feature vector 425.

In accordance with other embodiments, the speech processing module 400 of FIG. 4 includes one or more recurrent connections. In one embodiment, the acoustic model includes recurrent models, e.g. LSTMs. In another embodiment, there may be feedback between modules. In FIG. 4 there is a dashed line indicating a first recurrent coupling between the utterance parser 436 and the language model 434 and a dashed line indicating a second recurrent coupling between the language model 434 and the acoustic model 432. In this embodiment, a current state of the utterance parser 436 may be used to configure a future prediction of the language model 434 and a current state of the language model 434 may be used to configure a future prediction of the acoustic model 432. The recurrent coupling is omitted in certain embodiments to simplify the processing pipeline and allow for easier training. In one case, the recurrent coupling is used to compute an attention or weighting vector that is applied at a next time step.

### Neural Speaker Preprocessing Module

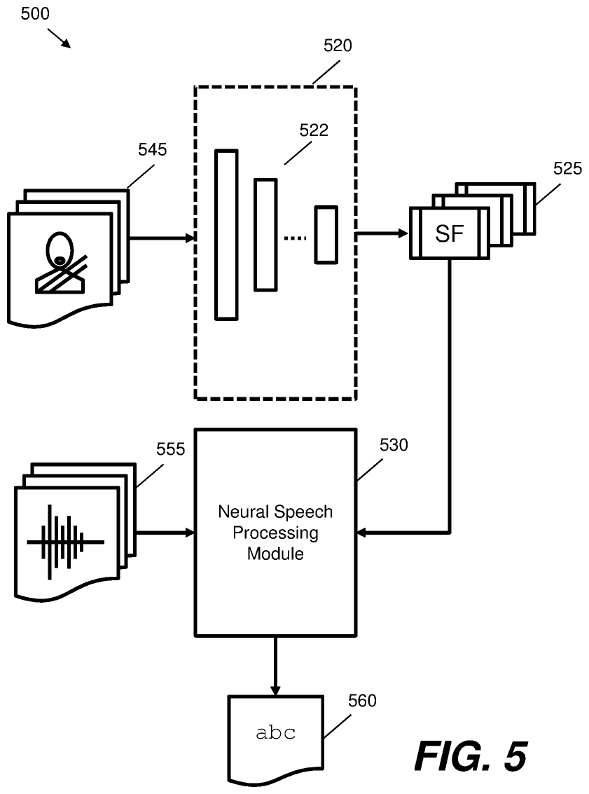

FIG. 5 shows an example speech processing apparatus 500 that uses a neural speaker preprocessing module 520 and a neural speech processing module 530 in accordance with various aspects and embodiments. In FIG. 5, the speaker preprocessing module 520, which may implement modules 220 or 320 in FIGS. 2 and 3, respectively, includes a neural network architecture 522. In FIG. 5, the neural network architecture 522 is configured to receive image data 545. In accordance with various aspects and embodiments, the neural network architecture 522 may also receive audio data, such as audio data 355, e.g., as shown by the dashed pathway in FIG. 3. In these other embodiments, the vector generator 372 of FIG. 3 includes the neural network architecture 522.

In FIG. 5, the neural network architecture 522 includes at least a convolutional neural architecture. In certain architectures there may be one or more feed-forward neural network layers between a last convolutional neural network layer and an output layer of the neural network architecture 522. The neural network architecture 522 includes an adapted form of the AlexNet, VGGNet, GoogLeNet, or ResNet architectures. The neural network architecture 522 may be replaced in a modular manner as more accurate architectures become available.

The neural network architecture 522 outputs at least one speaker feature vector 525, where the speaker feature vector 525 may be derived and/or used as described in any of the other examples. FIG. 5 shows a case where the image data 545 includes a plurality of frames, e.g., from a video camera, wherein the frames feature a facial area of a person. Accordingly, a plurality of speaker feature vectors 525 may be computed using the neural network architecture 522, e.g., one for each input frame of image data. In other embodiments, there may be a many-to-one relationship between frames of input data and a speaker feature vector. It should be noted that using recurrent neural network systems, samples of the input image data 545 and the output speaker feature vectors 525 need not be temporally synchronized, e.g., a recurrent neural network architecture may act as an encoder (or integrator) over time. In one embodiment, the neural network architecture 522 is configured to generate an x-vector as described above. In another embodiment, an x-vector generator is configured to receive image data 545, to process the image data 545 using a convolutional neural network architecture and then to combine the output of the convolutional neural network architecture with an audio-based x-vector. In another embodiment, known x-vector configurations are extended to receive image data as well as audio data and to generate a single speaker feature vector that embodies information from both modal pathways.

In FIG. 5, the neural speech processing module 530 is a speech processing module such as one of modules 230, 330, 400 that includes a neural network architecture in accordance with various aspects and embodiments. For example, the neural speech processing module 530 includes a hybrid DNN-HMM/GMM system and/or a fully neural CTC system. In FIG. 5, the neural speech processing module 530 receives frames of audio data 555 as input. Each frame may correspond to a temporal window, e.g., a window of w ms that is passed over time series data from an audio capture device. The frames of audio data 555 may by asynchronous with the frames of image data 545, e.g., it is likely that the frames of audio data 555 will have a higher frame rate. Again, holding mechanisms and/or recurrent neural network architectures may be applied within the neural speech processing module 530 to provide temporal encoding and/or integration of samples. As in other examples, the neural speech processing module 530 is configured to process the frames of audio data 555 and the speaker feature vectors 525 to generate a set of linguistic features 560. As discussed herein, reference to a neural network architecture includes one or more neural network layers (in one case, “deep” architectures with one or more hidden layers and a plurality of layers), wherein each layer may be separated from a following layer by non-linearities such as tan h units or REctified Linear Units (RELUs). Other functions may be embodied within the layers including pooling operations.

The neural speech processing module 530 includes one or more components as shown in FIG. 4. For example, the neural speech processing module 530 includes an acoustic model that includes at least one neural network. In the example of FIG. 5, the neural network architectures of the neural speaker preprocessing module 520 and the neural speech processing module 530 may be jointly trained. In this case, a training set includes frames of image data 545, frames of audio data 555 and ground truth linguistic features (e.g., ground truth phoneme sequences, text transcriptions or voice command classifications and command parameter values). Both the neural speaker preprocessing module 520 and the neural speech processing module 530 may be training in an end-to-end manner using this training set. In accordance with various aspects and embodiments, errors between predicted and ground truth linguistic features may be back propagated through the neural speech processing module 530 and then the neural speaker preprocessing module 520. Parameters for both neural network architectures may then be determined using gradient descent approaches. In this manner, the neural network architecture 522 of the neural speaker preprocessing module 520 may “learn” parameter values (such as values for weights and/or biases for one or more neural network layers) that generate one or more speaker feature vectors 525 that improve at least acoustic processing in an in-vehicle environment, where the neural speaker preprocessing module 520 learns to extract features from the facial area of a person that improves the accuracy of the output linguistic features.

Training of neural network architectures as described herein is typically not performed on in-vehicle device (although this could be performed if desired). In one embodiment, training may be performed on a computing device with access to substantive processing resources, such as a server computer device with multiple processing units (whether CPUs, GPUs, Field Programmable Gate Arrays—FPGAs—or other dedicated processor architectures) and large memory portions to hold batches of training data. In certain cases, training may be performed using a coupled accelerator device, e.g., a couplable FPGA or GPU-based device. In certain cases, trained parameters may be communicated from a remote server device to an embedded system within the vehicle, e.g. as part of an over-the-air update.

### Example of Acoustic Model Selection

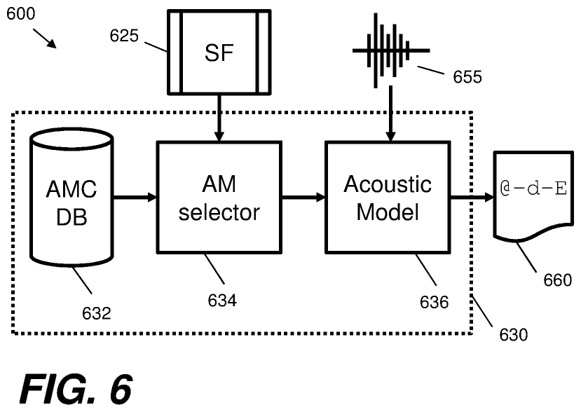

FIG. 6 shows an example speech processing module 600 that uses a speaker feature vector 625 to configure an acoustic model in accordance with various aspects and embodiments. The speech processing module 600 may be used to implement, at least in part, one of the speech processing modules described in other embodiments. In FIG. 6, the speech processing module 600 includes a database of acoustic model configurations 632, an acoustic model selector 634 and an acoustic model instance 636. The database of acoustic model configurations 632 stores a number of parameters to configure an acoustic model. In this example, the acoustic model instance 636 includes a general acoustic model that is instantiated (e.g., configured or calibrated) using a particular set of parameter values from the database of acoustic model configurations 632. For example, the database of acoustic model configurations 636 stores a plurality of acoustic model configurations. Each acoustic model configuration is associated with a different user, including one or more default acoustic model configurations that are used if a user is not detected or a user is detected but not specifically recognized.

In certain embodiments, the speaker feature vector 625 may be used to represent a particular regional accent instead of (or as well as) a particular user. This may be useful in countries such as India where there may be many different regional accents. In this case, the speaker feature vector 625 is used to dynamically load acoustic models based on an accent recognition that is performed using the speaker feature vector 625. For example, this may be possible in the case that the speaker feature vector 625 includes an x vector as described above. This is useful in a case with a plurality of accent models (e.g. multiple acoustic model configurations for each accent) that are stored within a memory of the vehicle. This allows a plurality of separately trained accent models to be used.

In one embodiments, the speaker feature vector 625 includes a classification of a person within a vehicle. For example, the speaker feature vector 625 is derived from the user identifier 376 output by the face recognition module 370 in FIG. 3. In another case, the speaker feature vector 625 includes a classification and/or set of probabilities output by a neural speaker preprocessing module such as module 520 in FIG. 5. In the latter case, the neural speaker preprocessing module includes a SoftMax layer that outputs “probabilities” for a set of potential users (including a classification for “unrecognized”). In this case, one or more frames of input image data 545 may result in a single speaker feature vector 525.

In FIG. 6, the acoustic model selector 634 receives the speaker feature vector 625, e.g., from a speaker preprocessing module, and selects an acoustic model configuration from the database of acoustic model configurations 632. This may operate in a similar manner to the example of FIG. 3 described above. If the speaker feature vector 625 includes a set of user classifications, then the acoustic model selector 634 may select an acoustic model configuration based on these classifications, e.g., by sampling a probability vector and/or selecting a largest probability value as a determined person. Parameter values relating to a selected configuration are retrieved from the database of acoustic model configurations 632 and used to instantiate the acoustic model instance 636. Hence, different acoustic model instances are used for different identified users within the vehicle.

In FIG. 6, the acoustic model instance 636, e.g., as configured by the acoustic model selector 634 using a configuration retrieved from the database of acoustic model configurations 632, also receives audio data 655. The acoustic model instance 636 is configured to generate phoneme data 660 for use in parsing an utterance associated with the audio data 655 (e.g., featured within the audio data 655). The phoneme data 660 includes a sequence of phoneme symbols, e.g., from a predefined alphabet or dictionary. Hence, in the example of FIG. 6, the acoustic model selector 634 selects an acoustic model configuration from the database of acoustic model configurations 632 based on a speaker feature vector, and the acoustic model configuration is used to instantiate an acoustic model instance 636 to process the audio data 655.

The acoustic model instance 636 includes both neural and non-neural architectures. In one embodiment, the acoustic model instance 636 includes a non-neural model. For example, the acoustic model instance 636 includes a statistical model. The statistical model may use symbol frequencies and/or probabilities. In one embodiment, the statistical model includes a Bayesian model, such as a Bayesian network or classifier. In these embodiments, the acoustic model configurations includes particular sets of symbol frequencies and/or prior probabilities that have been measured in different environments. The acoustic model selector 634, thus, allows a particular source (e.g., person or user) of an utterance to be determined based on visual (and in certain cases audio) information, which provides improvements over using audio data 655 on its own to generate phoneme sequence 660.

In another embodiment, the acoustic model instance 636 includes a neural model. The acoustic model selector 634 and the acoustic model instance 636 include neural network architectures. In accordance with various aspects and embodiments, the database of acoustic model configurations 632 may be omitted and the acoustic model selector 634 supplies a vector input to the acoustic model instance 636 to configure the instance. In this embodiment, training data may be constructed from image data used to generate the speaker feature vector 625, audio data 655, and ground truth sets of phoneme outputs 660. Such a system may be jointly trained.

### Example Image Preprocessing

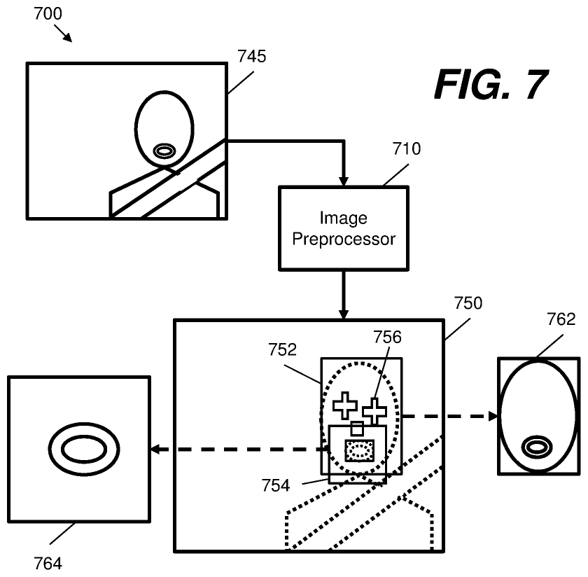

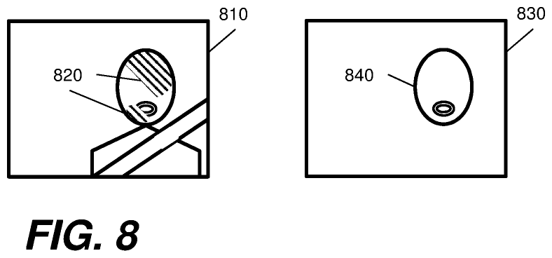

FIGS. 7 and 8 show example image preprocessing operations applied to image data obtained from within a vehicle, such as a motor vehicle, in accordance with various aspects and embodiments. FIG. 7 shows an example image preprocessing pipeline 700 including an image preprocessor 710. The image preprocessor 710 includes any combination of hardware and software to implement functionality as described herein. In one embodiment, the image preprocessor 710 includes hardware components that form part of image capture circuitry that is coupled to one or more image capture devices. In another embodiment, the image preprocessor 710 is implemented by computer program code (such as firmware) that is executed by a processor of an in-vehicle control system. In one embodiment, the image preprocessor 710 is implemented as part of the speaker preprocessing module described in various embodiments herein. In various embodiments, the image preprocessor 710 is in communication with the speaker preprocessing module.

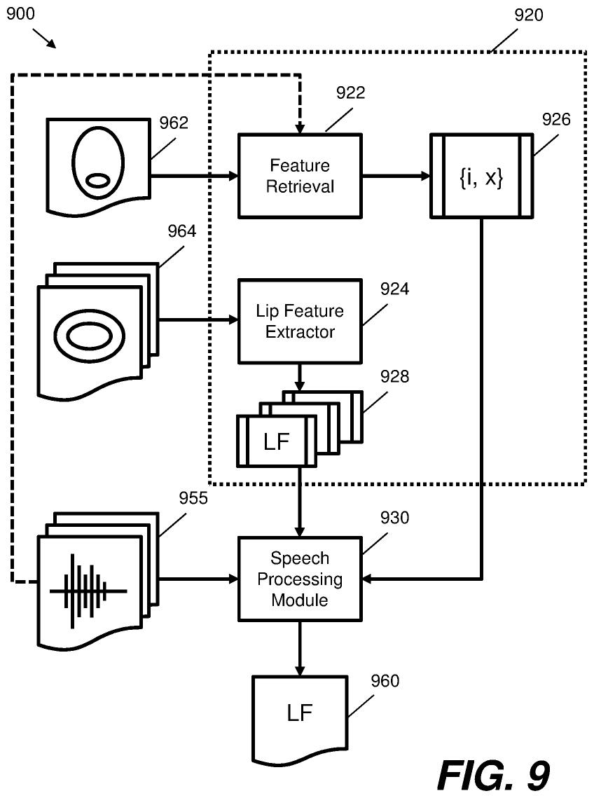

In FIG. 7, the image preprocessor 710 receives image data 745, such as an image from image capture device 110 in FIG. 1A. The image preprocessor 710 processes the image data to extract one or more portions of the image data. FIG. 7 shows an output 750 of the image preprocessor 710. The output 750 includes one or more image annotations, e.g., metadata associated with one or more pixels of the image data 745 and/or features defined using pixel co-ordinates within the image data 745. In the example of FIG. 7, the image preprocessor 710 performs face detection on the image data 745 to determine a first image area 752. The first image area 752 is cropped and extracted as image portion 762. The first image area 752 is defined using a bounding box (e.g., at least top left and bottom right (x, y) pixel co-ordinates for a rectangular area). The face detection is a pre-cursor step for face recognition, e.g., face detection determines a face area within the image data 745 and face recognition may classify the face area as belonging to a given person (e.g., within a set of people). In the example of FIG. 7, the image preprocessor 710 also identifies a mouth area within the image data 745 to determine a second image area 754. The second image area 754 may be cropped and extracted as image portion 764. The second image area 754 may also be defined using a bounding box. In accordance with one aspect, the first image area 752 and the second image area 754 are determined in relation to a set of detected facial features 756. These facial features 756 includes one or more of eyes, nose and mouth areas. Detection of facial features 756 and/or one or more of the first image area 752 and the second image area 754 may use neural network approaches, or known face detection algorithms such as the Viola-Jones face detection algorithm as described in “Robust Real-Time Face Detection”, by Paul Viola and Michael J Jones, as published in the International Journal of Computer Vision 57, pp. 137-154, Netherlands, 2004, which is incorporated herein by reference. In certain examples, one or more of the first image area 752 and the second image area 754 are used by the speaker preprocessing modules described herein to obtain a speaker feature vector. For example, the first image area 752 provides input image data for the face recognition module 370 in FIG. 3 (i.e. be used to supply image data 345). An example that uses the second image area 754 is described with reference to FIG. 9 below.

FIG. 8 shows an effect of using an image capture device configured to capture electromagnetic radiation having infra-red wavelengths. In certain cases, image data 810 obtained by an image capture device, such as image capture device 110 in FIG. 1A, may be impacted by low light situations. In FIG. 8, the image data 810 contains areas of shadow 820 that partially obscure the facial area (e.g., including the first and second image areas 752, 754 in FIG. 7). In these cases, an image capture device that is configured to capture electromagnetic radiation having infra-red wavelengths is used in accordance with various aspects and embodiments. This includes providing adaptations to the image capture device 110 in FIG. 1A (e.g., such as removable filters in hardware and/or software) and/or providing a Near-Infra-Red (NIR) camera. An output from such an image capture device is shown in schematically as image data 830. In image data 830, the facial area 840 is reliably captured. Thus, the image data 830 provides a representation that is illumination invariant, e.g., that is not affected by changes in illumination, such as those that may occur in night driving. The image data 830 is provided to the image preprocessor 710 and/or the speaker preprocessing modules as described herein.

### Lip Reading Examples

In certain examples, the speaker feature vector described herein includes at least a set of elements that represent mouth or lip features of a person. In these cases, the speaker feature vector may be speaker dependent as it changes based on the content of image data featuring the mouth or lip area of a person. In the example of FIG. 5, the neural speaker preprocessing module 520 may encode lip or mouth features that are used to generate the speaker feature vectors 525. These may be used to improve the performance of the speech processing module 530.

FIG. 9 shows another example speech processing apparatus 900 that uses lip features to form at least part of a speaker feature vector in accordance with various aspects and embodiments. As with previous examples, the speech processing apparatus 900 includes a speaker preprocessing module 920 and a speech processing module 930. The speech processing module 930 receives audio data 955 (in this case, frames of audio data) and outputs linguistic features 960. The speech processing module 930 may be configured as per other examples described herein.

In FIG. 9, the speaker preprocessing module 920 is configured to receive two different sources of image data in accordance with various aspects and embodiments. In accordance with one embodiment, the speaker preprocessing module 920 receives a first set of image data 962 that features a facial area of a person. This includes the first image area 762 as extracted by the image preprocessor 710 in FIG. 7. The speaker preprocessing module 920 also receives a second set of image data 964 that features a lip or mouth area of a person. This includes the second image area 764 as extracted by the image preprocessor 710 in FIG. 7. The second set of image data 964 may be relatively small, e.g., a small cropped portion of a larger image obtained using the image capture device 110 of FIG. 1A. In other examples, the first set of image data 962 and the second set of image data 964 may not be cropped and include copies of a set of images from an image capture device. Different configurations are possible—cropping the image data improves processing speed and training. Neural network architectures may be trained to operate on a wide variety of image sizes.

The speaker preprocessing module 920 includes two components in FIG. 9: a feature retrieval component 922 and a lip feature extractor 924. The lip feature extractor 924 forms part of a lip-reading module. The feature retrieval component 922 may be configured in a similar manner to the speaker preprocessing module 320 in FIG. 3. In one embodiment, the feature retrieval component 922 receives the first set of image data 962 and outputs a vector portion 926 that includes of one or more of an i*-vector and an x-vector (e.g., as described above). In accordance with one aspect, the feature retrieval component 922 receives a single image per utterance. The lip feature extractor 924 and the speech processing module 930 receive a plurality of frames over the time of the utterance. In one case, if a facial recognition performed by the feature retrieval component 922 has a confidence value that is below a threshold, the first set of image data 962 may be updated (e.g., by using another/current frame of video) and the facial recognition reapplied until a confidence value meets a threshold (or a predefined number of attempts is exceeded). As described with reference to FIG. 3, the vector portion 926 may be computed based on the audio data 955 for a first number of utterances, and then retrieved as a static value from memory once the first number of utterances is exceeded.

The lip feature extractor 924 receives the second set of image data 964. The second set of image data 964 includes cropped frames of image data that focus on a mouth or lip area. The lip feature extractor 924 may receive the second set of image data 964 at a frame rate of an image capture device and/or at a subsampled frame rate (e.g., every 2 frames). The lip feature extractor 924 outputs a set of vector portions 928. These vector portions 928 include an output of an encoder that includes a neural network architecture. The lip feature extractor 924 includes a convolutional neural network architecture to provide a fixed-length vector output (e.g., 256 or 512 elements having integer or floating-point values). The lip feature extractor 924 may output a vector portion for each input frame of image data 964 and/or may encode features over time steps using a recurrent neural network architecture (e.g., using a Long Short Term Memory—LSTM—or Gated Recurrent Unit—GRU) or a “transformer” architecture. In the latter case, an output of the lip feature extractor 924 includes one or more of a hidden state of a recurrent neural network and an output of the recurrent neural network. One example implementation for the lip feature extractor 924 is described by Chung, Joon Son, et al. in “Lip reading sentences in the wild”, 2017 IEEE Conference on Computer Vision and Pattern Recognition (CVPR), which is incorporated herein by reference.

In FIG. 9, the speech processing module 930 receives the vector portions 926 from the feature retrieval component 922 and the vector portions 928 from the lip feature extractor 924 as inputs. In one embodiment, the speaker preprocessing module 920 may combine the vector portions 926 and 928 into a single speaker feature vector. In another embodiment, the speech processing module 930 may receive the vector portions 926 and 928 separately yet treat the vector portions as different portions of a speaker feature vector. The vector portions 926 and 928 may be combined into a single speaker feature vector by one or more of the speaker preprocessing module 920 and the speech processing module 920 using, for example, concatenation or more complex attention-based mechanisms. If the sample rates of one or more of the vector portions 926, the vector portions 928 and the frames of audio data 955 differ then a common sample rate may be implemented by, for example, a receive-and-hold architecture (where values that more vary more slower are held constant at a given value until a new sample values are received), a recurrent temporal encoding (e.g., using LSTMs or GRUs as above) or an attention-based system where an attention weighting vector changes per time step.

In accordance with various aspects and embodiments, the speech processing module 930 may be configured to use the vector portions 926 and 928 as described in other examples set out herein, e.g., these may be input as a speaker feature vector into a neural acoustic model along with the audio data 955. In an example where the speech processing module 930 includes a neural acoustic model, a training set may be generated based on input video from an image capture device, input audio from an audio capture device and ground-truth linguistic features (e.g., the image preprocessor 710 in FIG. 7 may be used to obtain the first and second sets of image data 962, 964 from raw input video).

In certain examples, the vector portions 926 may also include an additional set of elements whose values are derived from an encoding of the first set of image data 962, e.g., using a neural network architecture such as 522 in FIG. 5. These additional elements may represent a “face encoding” while the vector portions 928 may represent a “lip encoding”. The face encoding may remain static for the utterance whereas the lip encoding may change during, or include multiple “frames” for, the utterance. Although FIG. 9 shows an example that uses both a lip feature extractor 924 and a feature retrieval component 922, in accordance with various aspects and embodiments the feature retrieval component 922 may be omitted and a lip-reading system for in vehicle use may be used in a manner similar to the speech processing apparatus 500 of FIG. 5.

### Example Motor Vehicle

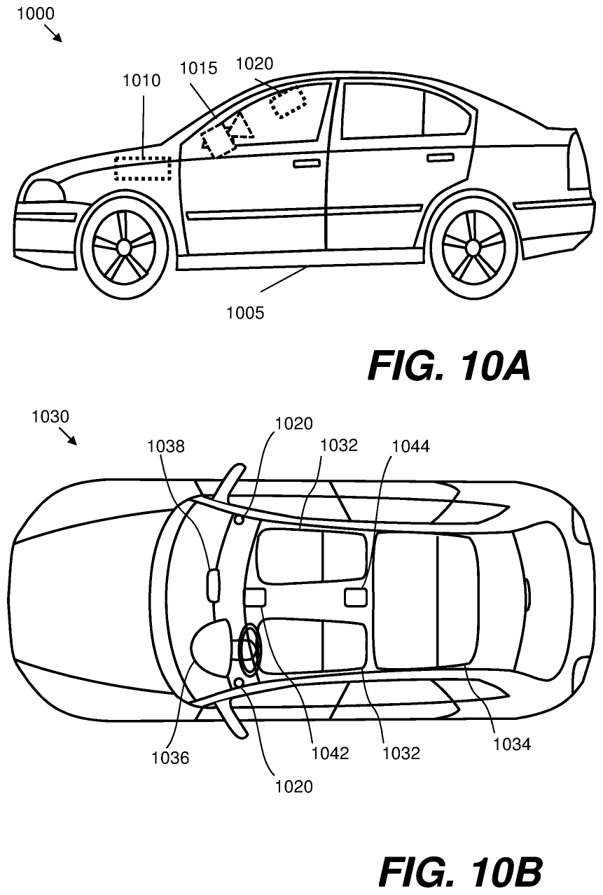

FIGS. 10A and 10B show an example where the vehicle as described herein is a motor vehicle in accordance with various aspects and embodiments. FIG. 10A shows a side view 1000 of a motor vehicle or an automobile 1005. The automobile 1005 includes a control unit 1010 for controlling components of the automobile 1005. The components of the speech processing apparatus 120 as shown in FIG. 1B (as well as the other examples) may be incorporated into this control unit 1010 in accordance with various aspects and embodiments. In accordance with various other aspects and embodiments, the components of the speech processing apparatus 120 may be implemented as a separate unit with an option of connectivity with the control unit 1010. The automobile 1005 also includes at least one image capture device 1015. For example, the at least one image capture device 1015 includes the image capture device 110 shown in FIG. 1A. In accordance with various aspects and embodiments, the at least one image capture device 1015 is communicatively coupled to, and controlled by, the control unit 1010. In accordance with other aspects and embodiments, the at least one image capture device 1015 is in communication with the control unit 1010 and remotely controlled. As well as the functions described herein, the at least one image capture device 1015 may be used for video communications, e.g., voice-over-Internet Protocol calls with video data, environmental monitoring, driver alertness monitoring etc. FIG. 10A also shows at least one audio capture device in the form of side-mounted microphones 1020. These may implement the audio capture device 116 shown in FIG. 1A.

The image capture devices describe herein includes one or more still or video cameras that are configured to capture frames of image data on command or at a predefined sampling rate. Image capture devices may provide coverage of both the front and rear of the vehicle interior. In accordance with various aspects and embodiments, a predefined sampling rate may be less than a frame rate for full resolution video, e.g., a video stream may be captured at 30 frames per second, but a sampling rate of the image capture device may capture at this rate, or at a lower rate, such as 1 frame per second. An image capture device may capture one or more frames of image data having one or more color channels (e.g., RGB or YUV as described above). In certain cases, aspects of an image capture device, such as the frame rate, frame size and resolution, number of color channels and sample format may be configurable. The frames of image data may be downsampled in certain cases, e.g., video capture device that captures video at a “4K” resolution of 3840×2160 may be downsampled to 640×480 or below. Alternatively, for low-cost embedded devices, a low-resolution image capture device may be used, capturing frames of image data at 320×240 or below. In certain cases, even cheap low-resolution image capture devices may provide enough visual information for speech processing to be improved. As before, an image capture device may also include image pre-processing and/or filtering components (e.g., contrast adjustment, noise removal, color adjustment, cropping, etc.). In certain cases, low latency and/or high frame rate image cameras that meet more strict Automotive Safety Integrity Level (ASIL) levels for the ISO 26262 automotive safety standard are available. Aside from their safety benefits, they can improve lip reading accuracy by providing higher temporal information. That can be useful to recurrent neural networks for more accurate feature probability estimation.

FIG. 10B shows an overhead view 1030 of automobile 1005 in accordance with various aspects and embodiments. It includes front seats 1032 and rear seat 1034 for holding passengers in an orientation for front-mounted microphones for speech capture. The automobile 1005 includes a driver visual console 1036 with safety-critical display information. The driver visual console 1036 includes part of the dashboard 108 as shown in FIG. 1A. The automobile 1005 further includes a general console 1038 with navigation, entertainment, and climate control functions. The control unit 1010 may control the general console 1038 and may implement a local speech processing module such as 120 in FIG. 1A and a wireless network communication module. The wireless network communication module may transmit one or more of image data, audio data and speaker feature vectors that are generated by the control unit 1010 to a remote server for processing. The automobile 1005 further includes the side-mounted microphones 1020, a front overhead multi-microphone speech capture unit 1042, and a rear overhead multi-microphone speech capture unit 1044. The front and rear speech capture units 1042 and 1044 provide additional audio capture devices for capturing speech audio, canceling noise, and identifying the location of speakers. In one case, the front and rear speech capture units 1042 and 1044 may also include additional image capture devices to capture image data featuring each of the passengers of the vehicle.

In the example of FIG. 10B, any one or more of the microphones and speech capture units 1020, 1042 and 1044 may provide audio data to an audio interface such as 140 in FIG. 1B. The microphone or array of microphones may be configured to capture or record audio samples at a predefined sampling rate. In certain cases, aspects of each audio capture device, such as the sampling rate, bit resolution, number of channels and sample format may be configurable. Captured audio data may be Pulse Code Modulated. Any audio capture device may also include audio pre-processing and/or filtering components (e.g., contrast adjustment, noise removal, etc.). Similarly, any one or more of the image capture devices may provide image data to an image interface such as 150 in FIG. 1B and may also include video pre-processing and/or filtering components (e.g., contrast adjustment, noise removal, etc.).

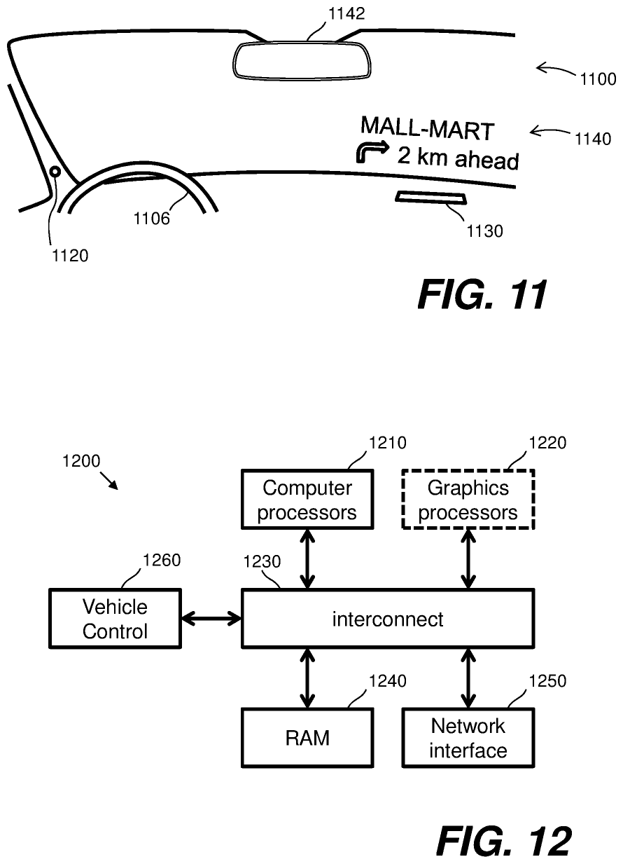

FIG. 11 shows an example of an interior of an automobile 1100 as viewed from the front seats 1032 in accordance with various aspects and embodiments. For example, FIG. 11 includes a view towards the windshield 104 of FIG. 1A. FIG. 11 shows a steering wheel 1106 (such as steering wheel 106 in FIG. 1), a side microphone 1120 (such as one of side microphones 1020 in FIGS. 10A and 10B), a rear-view mirror 1142 (that includes front overhead multi-microphone speech capture unit 1042) and a projection device 1130. The projection device 1130 may be used to project images 1140 onto the windshield, e.g., for use as an additional visual output device (e.g., in additional to the driver visual console 1036 and the general console 1038). In FIG. 11, the images 1140 comprise directions. These may be directions that are projected following a voice command of “Find me directions to the Mall-Mart”. Other examples may use a simpler response system.

### Local and Remote Speech Processing for a Vehicle

In certain cases, the functionality of the speech processing modules as described herein may be distributed. For example, certain functions may be computed locally within the automobile 1005 and certain functions may be computed by a remote (“cloud”) server device. In certain cases, functionality may be duplicated on the automobile (“client”) side and the remote server device (“server”) side. In these cases, if a connection to the remote server device is not available then processing may be performed by a local speech processing module; if a connection to the remote server device is available then one or more of the audio data, image data and speaker feature vector may be transmitted to the remote server device for parsing a captured utterance. A remote server device may have processing resources (e.g., Central Processing Units—CPUs, Graphical Processing Units—GPUs and Random-Access Memory) and so offer improvements on local performance if a connection is available. This may be traded-off against latencies in the processing pipeline (e.g., local processing is more responsive). In one case, a local speech processing module may provide a first output, and this may be complemented and/or enhanced by a result of a remote speech processing module.

In one embodiment, the vehicle, e.g., the automobile 1005, is communicatively coupled to a remote server device over at least one network. The network includes one or more local and/or wide area networks that may be implemented using a variety of physical technologies (e.g., wired technologies such as Ethernet and/or wireless technologies such as Wi-Fi—IEEE 802.11—standards and cellular communications technologies). In certain cases, the network includes a mixture of one or more private and public networks such as the Internet. The vehicle and the remote server device may communicate over the network using different technologies and communication pathways.

With reference to the example speech processing apparatus 300 of FIG. 3, in one case vector generation by the vector generator 372 may be performed either locally or remotely but the data store 374 is located locally within the automobile 1005. In this case, a static speaker feature vector may be computed locally and/or remotely but stored locally within the data store 374. Following this, the speaker feature vector 325 may be retrieved from the data store 374 within the automobile rather than received from a remote server device. This may improve a speech processing latency.

In a case where a speech processing module is remote from the vehicle, a local speech processing apparatus includes a transceiver to transmit data derived from one or more of audio data, image data and the speaker feature vector to the speech processing module and to receive control data from the parsing of the utterance. In one case, the transceiver includes a wired or wireless physical interface and one or more communications protocols that provide methods for sending and/or receiving requests in a predefined format. In one case, the transceiver includes an application layer interface operating on top of an Internet Protocol Suite. In this case, the application layer interface may be configured to receive communications directed towards a particular Internet Protocol address identifying a remote server device, with routing based on path names or web addresses being performed by one or more proxies and/or communication (e.g., “web”) servers.

In certain cases, linguistic features generated by a speech processing module may be mapped to a voice command and a set of data for the voice command (e.g., as described with reference to the utterance parser 436 in FIG. 4). In one case, the utterance data 442 may be used by the control unit 1010 of automobile 1005 and used to implement a voice command. In one case, the utterance parser 436 may be located within a remote server device and utterance parsing may involve identifying an appropriate service to execute the voice command from the output of the speech processing module. For example, the utterance parser 436 may be configured to make an application programming interface (API) request to an identified server, the request comprising a command and any command data identified from the output of the language model. For example, an utterance of “Where is the Mall Mart?” may result in a text output of “where is the mall mart” that may be mapped to a directions service API request for vehicle mapping data with a desired location parameter of “mall mart” and a current location of the vehicle, e.g., as derived from a positioning system such as the Global Positioning System. The response may be retrieved and communicated to the vehicle, where it may be displayed as illustrated in FIG. 11.

In one case, a remote utterance parser 436 communicates response data to the control unit 1010 of the automobile 1005. This includes machine readable data to be communicated to the user, e.g., via a user interface or audio output. The response data may be processed and a response to the user may be output on one or more of the driver visual console 1036 and the general console 1038. Providing a response to a user includes the display of text and/or images on a display screen of one or more of the driver visual console 1036 and the general console 1038, or an output of sounds via a text-to-speech module. In certain cases, the response data includes audio data that may be processed at the control unit 1005 and used to generate an audio output, e.g., via one or more speakers. A response may be spoken to a user via speakers mounted within the interior of the automobile 1005.

### Example Embedded Computing System

FIG. 12 shows an example embedded computing system 1200 that may implement a speech processing apparatus in accordance with various aspects and embodiments. A system similar to the embedded computing system 1200 may be used to implement the control unit 1010 in FIG. 10. The example embedded computing system 1200 includes one or more computer processor (CPU) cores 1210 and zero or more graphics processor (GPU) cores 1220. The processors connect through a board-level interconnect 1230 to random-access memory (RAM) devices 1240 for program code and data storage. The embedded computing system 1200 also includes a network interface 1250 to allow the processors to communicate with remote systems and specific vehicle control circuitry 1260. By executing instructions stored in RAM devices 1240 through interconnect 1230, interface 1250, the CPUs 1210 and/or GPUs 1220 may perform functionality as described herein. In certain cases, constrained embedded computing devices may have a similar general arrangement of components, but in certain cases may have fewer computing resources and may not have dedicated graphics processors 1220.

### Example Speech Processing Method

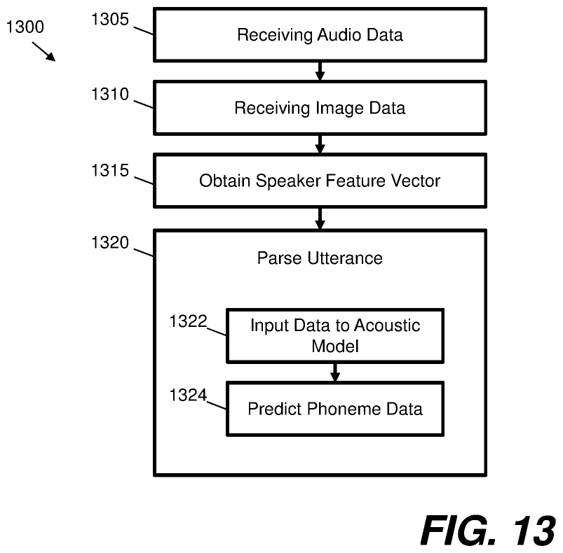

FIG. 13 shows an example method 1300 for processing speech that improves in-vehicle speech recognition in accordance with various aspects and embodiments. The method 1300 begins at block 1305 where audio data is received from an audio capture device. The audio capture device may be located within a vehicle. The audio data may feature an utterance from a user. Block 1305 includes capturing data from one or more microphones, such as devices 1020, 1042 and 1044 in FIGS. 10A and 10B. In accordance with various aspects and embodiments, block 1305 includes receiving audio data over a local audio interface. In accordance with other aspects and embodiments, block 1305 includes receiving audio data over a network, e.g., at an audio interface that is remote from the vehicle.

At block 1310, image data from an image capture device is received. The image capture device may be located within the vehicle, e.g., includes the image capture device 1015 in FIGS. 10A and 10B. In accordance with various aspects and embodiments, block 1310 includes receiving image data over a local image interface In accordance with other aspects and embodiments, block 1310 includes receiving image data over a network, e.g., at an image interface that is remote from the vehicle.

At block 1315, a speaker feature vector is obtained based on the image data. This includes, for example, implementing any one of the speaker preprocessing modules 220, 320, 520 and 920. Block 1315 may be performed by a local processor of the automobile 1005 or by a remote server device. At block 1320, the utterance is parsed using a speech processing module. For example, this includes implementing any one of the speech processing modules 230, 330, 400, 530 and 930. Block 1320 includes a number of subblocks. At subblock 1322, providing the speaker feature vector and the audio data as an input to an acoustic model of the speech processing module. This includes operations similar to those described with reference to FIG. 4. In certain cases, the acoustic model includes a neural network architecture. At subblock 1324, phoneme data is predicted, using at least the neural network architecture, based on the speaker feature vector and the audio data. This includes using a neural network architecture that is trained to receive the speaker feature vector as an input in additional to the audio data. As both the speaker feature vector and the audio data comprise numeric representations, these may be processed similarly by the neural network architecture. In certain cases, an existing CTC or hybrid acoustic model may be configured to receive a concatenation of the speaker feature vector and the audio data, and then trained using a training set that additionally includes image data (e.g., that is used to derive the speaker feature vector).

In certain cases, block 1315 includes performing facial recognition on the image data to identify the person within the vehicle. For example, this may be performed as described with reference to face recognition module 370 in FIG. 3. Following this, user profile data for the person (e.g., in the vehicle) may be obtained based on the facial recognition. For example, user profile data may be retrieved from the data store 374 using a user identifier 376 as described with reference to FIG. 3. The speaker feature vector may then be obtained in accordance with the user profile data. In one embodiment, the speaker feature vector is retrieved as a static set of element values from the user profile data. In another embodiment, the user profile data indicates that the speaker feature vector is to be computed, e.g., using one or more of the audio data and the image data received at blocks 1305 and 1310. In certain embodiments, block 1315 includes comparing a number of stored speaker feature vectors associated with user profile data with a predefined threshold. For example, the user profile data may indicate how many previous voice queries have been performed by a user identified using face recognition. Responsive to the number of stored speaker feature vectors being below the predefined threshold, the speaker feature vector may be computed using one or more of the audio data and the image data. Responsive to the number of stored speaker feature vectors being greater than the predefined threshold, a static speaker feature vector may be obtained, e.g., one that is stored within or is accessible via the user profile data. In this case, the static speaker feature vector may be generated using the number of stored speaker feature vectors.

In certain embodiments, block 1315 includes processing the image data to generate one or more speaker feature vectors based on lip movement within the facial area of the person. For example, a lip-reading module, such as lip feature extractor 924 or a suitably configured neural speaker preprocessing module 520, may be used. The output of the lip-reading module is used to supply one or more speaker feature vectors to a speech processing module, and/or may be combined with other values (such as i or x-vectors) to generate a larger speaker feature vector.

In certain embodiments, block 1320 includes providing the phoneme data to a language model of the speech processing module, predicting a transcript of the utterance using the language model, and determining a control command for the vehicle using the transcript. For example, block 1320 includes operations similar to those described with reference to FIG. 4.

### Utterance Parsing Example

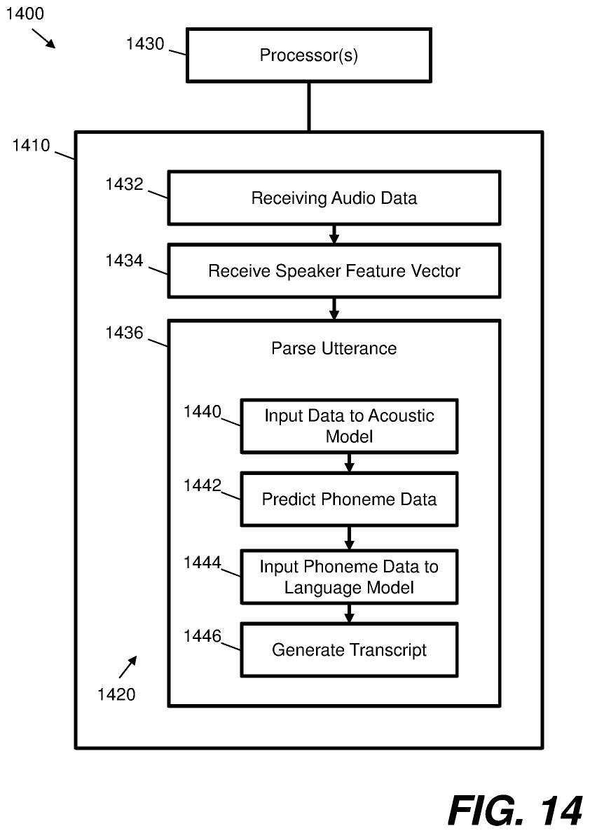

FIG. 14 shows an example processing system 1400 comprising a non-transitory computer-readable storage medium 1410 storing instructions 1420 which, when executed by at least one processor 1430, cause the at least one processor to perform a series of operations in accordance with various aspects and embodiments. The operations of this example use previously described approaches to generate a transcription of an utterance. These operations may be performed within a vehicle, e.g. as previously described, or extend an in-vehicle example to situations that are not vehicle-based, e.g., that may be implemented using desktop, laptop, mobile or server computing devices, amongst others.

Via instruction 1432, the processor 1430 is configured to receive audio data from an audio capture device. This includes accessing a local memory containing the audio data and/or receiving a data stream or set of array values over a network. The audio data may have a form as described with reference to other examples herein. Via instruction 1434, the processor 1430 is configured to receive a speaker feature vector. The speaker feature vector is obtained based on image data from an image capture device, the image data featuring a facial area of a user. For example, the speaker feature vector is obtained using the approaches described with reference to any of FIGS. 2, 3, 5 and 9. The speaker feature vector may be computed locally, e.g., by the processor 1430, accessed from a local memory, and/or received over a network interface (amongst others). Via instruction 1436, the processor 1430 is instructed to parse the utterance using a speech processing module. The speech processing module includes any of the modules described with reference to any of FIGS. 2, 3, 4, 5 and 9.

FIG. 14 shows that instruction 1436 may be broken down into a number of further instructions. Via instruction 1440, the processor 1430 is instructed to provide the speaker feature vector and the audio data as an input to an acoustic model of the speech processing module. This may be achieved in a manner similar to that described with reference to FIG. 4. In the present example, the acoustic model includes a neural network architecture. Via instruction 1442, the processor 1430 is instructed to predict, using at least the neural network architecture, phoneme data based on the speaker feature vector and the audio data. Via instruction 1444, the processor 1430 is instructed to provide the phoneme data to a language model of the speech processing module. This may also be performed in a manner similar to that shown in FIG. 4. Via instruction 1446, the processor 1430 is instructed to generate a transcript of the utterance using the language model. For example, the transcript may be generated as an output of the language model. In certain cases, the transcript may be used by a control system to execute a voice command, such as control unit 1010 in the automobile 1005. In other cases, the transcript includes an output for a speech-to-text system. In the latter case, the image data may be retrieved from a web-camera or the like that is communicatively coupled to the computing device comprising the processor 1430. For a mobile computing device, the image data may be obtained from a forward-facing image capture device.

In certain examples, the speaker feature vector received according to instructions 1434 includes one or more of: vector elements that are dependent on the speaker that are generated based on the audio data (e.g., i-vector or x-vector components); vector elements that are dependent on lip movement of the speaker that is generated based on the image data (e.g., as generated by a lip-reading module); and vector elements that are dependent on a face of the speaker that is generated based on the image data. In one case, the processor 1430 includes part of a remote server device and the audio data and the speaker image vector may be received from a motor vehicle, e.g., as part of a distributed processing pipeline.

### Example Implementations

Certain examples are described that relate to speech processing including automatic speech recognition. Certain examples relate to the processing of certain spoken languages. Various examples operate, similarly, for other languages or combinations of languages. Certain examples improve an accuracy and a robustness of speech processing by incorporating additional information that is derived from an image of a person making an utterance. This additional information may be used to improve linguistic models. Linguistic models include one or more of acoustic models, pronunciation models and language models.

Certain examples described herein may be implemented to address the unique challenges of performing automatic speech recognition within a vehicle, such as an automobile. In certain combined examples, image data from a camera may be used to determine lip-reading features and to recognize a face to enable an i-vector and/or x-vector profile to be built and selected. By implementing approaches as described herein it may be possible to perform automatic speech recognition within the noisy, multichannel environment of a motor vehicle.

Certain examples described herein may increase an efficiency of speech processing by including one or more features derived from image data, e.g. lip positioning or movement, within a speaker feature vector that is provided as an input to an acoustic model that also receives audio data as an input (a singular model), e.g. rather than having an acoustic model that only receives an audio input or separate acoustic models for audio and image data.

Certain methods and sets of operations may be performed by instructions that are stored upon a non-transitory computer readable medium. The non-transitory computer readable medium stores code comprising instructions that, if executed by one or more computers, would cause the computer to perform steps of methods described herein. The non-transitory computer readable medium includes one or more of a rotating magnetic disk, a rotating optical disk, a flash random access memory (RAM) chip, and other mechanically moving or solid-state storage media. Any type of computer-readable medium is appropriate for storing code comprising instructions according to various example.

Certain examples described herein may be implemented as so-called system-on-chip (SoC) devices. SoC devices control many embedded in-vehicle systems and may be used to implement the functions described herein. In one case, one or more of the speaker preprocessing module and the speech processing module may be implemented as a SoC device. An SoC device includes one or more processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. An SoC device may also comprise various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors of an SoC device may perform steps of methods as described herein.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of humans and machines. Method examples are complete wherever in the world most constituent steps occur. Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link. For example, a communication link may be established using a wired connection, wireless protocols, near-filed protocols, or RFID.

The scope of the invention, therefore, is not intended to be limited to the exemplary embodiments shown and described herein. Rather, the scope and spirit of present invention is embodied by the appended claims.

What is claimed is:

1. A vehicle-mounted apparatus for processing speech, the apparatus comprising:
an audio interface for receiving audio data from an audio capture device;
an image interface for receiving image data from an image capture device;
a speech processing module for parsing an utterance of a person based on the audio data and the image data; and
a speaker preprocessing module for receiving the image data and obtaining, based on the image data, a speaker feature vector to predict phoneme data.

2. The apparatus of claim 1, wherein the speech processing module includes an acoustic model configured to process the audio data and predict phoneme data for use in parsing the utterance.

3. The apparatus of claim 2, wherein the acoustic model includes a neural network architecture.

4. The apparatus of claim 2, wherein the acoustic model receives the speaker feature vector and the audio data as an input and is trained to use the speaker feature vector and the audio data to predict phoneme data.

5. The apparatus of claim 1, wherein the image data includes a facial area of the person within the vehicle.

6. The apparatus of claim 1, wherein the speaker preprocessing module performs facial recognition on the image data to identify the person within the vehicle and retrieves a speaker feature vector associated with the identified person.

7. The apparatus of claim 1, wherein the speaker preprocessing module includes a lip-reading module for generating one or more speaker feature vectors based on lip movement within a facial area of the person.

8. The apparatus of claim 1, wherein the speaker preprocessing module includes a neural network architecture, the neural network architecture receives data derived from one or more of the audio data and the image data and predicts the speaker feature vector.

9. The apparatus of claim 1, wherein the speaker preprocessing module computes a speaker feature vector for a predefined number of utterances and computes a static speaker feature vector based on a plurality of speaker feature vectors for a predefined number of utterances.

10. The apparatus of claim 1, further comprising memory for storing one or more user profiles, wherein the speaker preprocessing module:
performs facial recognition on the image data to identify a user profile, stored within the memory, associated with the person within the vehicle;
computes a speaker feature vector for the person;
stores the speaker feature vector in the memory; and
associates the stored speaker feature vector with the identified user profile.

11. The apparatus of claim 10, wherein the speaker preprocessing module determines whether a number of stored speaker feature vectors associated with a given user profile is greater than a predefined threshold and responsive to the predefined threshold being exceeded:
computes a static speaker feature vector based on the number of stored speaker feature vectors;
stores the static speaker feature vector in the memory;
associates the stored static speaker feature vector with the given user profile; and
signals that the static speaker feature vector is to be used for future utterance parsing in place of computation of the speaker feature vector for the person.

12. The apparatus of claim 1, wherein the image capture device captures electromagnetic radiation having infra-red wavelengths and sends the image data to the image interface.

13. The apparatus of claim 1, wherein the speaker preprocessing module processes the image data to extract one or more portions of the image data and the extracted one or more portions of the image data are used to obtain the speaker feature vector.

14. The apparatus of claim 1 further comprising a transceiver to transmit data derived from the audio data and the image data to a remote speech processing module, wherein the transceiver receives control data from the remote speech processing module when the remote speech processing module parses the utterance.

15. The apparatus of claim 1 further comprising an acoustic model, the acoustic model includes a hybrid acoustic model having a neural network architecture and a Gaussian mixture model, wherein the Gaussian mixture model is configured to receive a vector of class probabilities output by the neural network architecture and to output phoneme data for parsing the utterance.

16. The apparatus of claim 1 further comprising an acoustic model, the acoustic model includes a connectionist temporal classification (CTC) model.

17. The apparatus of claim 1, wherein the speech processing module comprises a language model communicatively coupled to an acoustic model to receive the phoneme data and to generate a transcription representing the utterance.

18. The apparatus of claim 17, wherein the language model uses the speaker feature vector to generate the transcription representing the utterance.

19. The apparatus of claim 1 further comprising an acoustic model, the acoustic model includes:
a database of acoustic model configurations;
an acoustic model selector to select an acoustic model configuration from the database based on the speaker feature vector; and
an acoustic model instance to process the audio data, the acoustic model instance being instantiated based on the acoustic model configuration selected by the acoustic model selector, the acoustic model instance being configured to generate the phoneme data for use in parsing the utterance.

20. The apparatus of claim 1, wherein the speaker feature vector is one or more of an i-vector and an x-vector.

21. The apparatus of claim 1, wherein the speaker feature vector comprises:
a first portion that is dependent on the person and generated based on the audio data; and
a second portion that is dependent on lip movement of the person and generated based on the image data.

22. The apparatus of claim 21, wherein the speaker feature vector further comprises a third portion that is dependent on a face of the person that is generated based on the image data.

23. A method of processing an utterance comprising:
receiving audio data from an audio capture device located within a vehicle, the audio data featuring an utterance of a person within the vehicle;
receiving image data from an image capture device located within the vehicle, the image data featuring a facial area of the person;
obtaining a speaker feature vector based on the image data; and
parsing the utterance using a speech processing module to generate phoneme data.

24. The method of claim 23, wherein the step of parsing includes:
providing the speaker feature vector and the audio data as an input to an acoustic model of the speech processing module, the acoustic model including a neural network architecture, and
predicting, using at least the neural network architecture, the phoneme data based on the speaker feature vector and the audio data.

25. The method of claim 23, wherein the step of obtaining a speaker feature vector comprises:
performing facial recognition on the image data to identify the person within the vehicle;
obtaining user profile data for the person based on the facial recognition; and
obtaining the speaker feature vector in accordance with the user profile data.

26. The method of claim 25 further comprising
comparing a number of stored speaker feature vectors associated with the user profile data with a predefined threshold;
computing, in response to the number of stored speaker feature vectors being below the predefined threshold, the speaker feature vector using one or more of the audio data and the image data; and
obtaining, in response to the number of stored speaker feature vectors being greater than the predefined threshold, a static speaker feature vector associated with the user profile data,
wherein the static speaker feature vector is generated using the number of stored speaker feature vectors.

27. The method of claim 23, wherein obtaining a speaker feature vector includes processing the image data to generate one or more speaker feature vectors based on lip movement within the facial area of the person.

28. The method of claim 23, wherein parsing the utterance includes:
providing the phoneme data to a language model of the speech processing module;
predicting a transcript of the utterance using the language model; and
determining a control command for the vehicle using the transcript.

29. A non-transitory computer-readable storage medium for storing instructions that, when executed by at least one processor, cause the at least one processor to:
receive audio data from an audio capture device;
receive a speaker feature vector, the speaker feature vector being obtained based on image data from an image capture device, the image data featuring a facial area of a user;
parse the utterance using a speech processing module;
provide the speaker feature vector and the audio data as an input to an acoustic model of the speech processing module, the acoustic model including a neural network architecture,
predict, using the neural network architecture, phoneme data based on the speaker feature vector and the audio data,
provide the phoneme data to a language model of the speech processing module, and
generate a transcript of the utterance using the language model.

30. The medium of claim 29, wherein the speaker feature vector comprises:
vector elements that are dependent on the speaker that are generated based on the audio data;
vector elements that are dependent on lip movement of the speaker that is generated based on the image data; and
vector elements that are dependent on a face of the speaker that is generated based on the image data.

31. The medium of claim 29, wherein the audio data and the speaker image vector are received from a motor vehicle.
